(19) United States
(12) Patent Application Publication
(10) Pub. No.: US 2007/0051684 A1
(43) Pub. Date: Mar. 8, 2007

(54) Sparse media edi apparatus and method

(76) Inventors: Vladimir Grebenyuk, Woburn, MA (US); William M. Carson, Hopkinton, MA (US); Oleg Grebenyuk, Ashland, MA (US); Keith J. Sims, Wayland, MA (US); Russell J. MacDonald, Wilmington, MA (US)

Correspondence Address: IONICS, INCORPORATED, 65 GROVE STREET, WATERTOWN, MA, 02453, US

(21) Appl. No.: 10/527,766

(22) PCT Filed: Sep. 12, 2003
(86) PCT No.: PCT/US03/28815

§ 371 Date: Jun. 5, 2005

Related U.S. Application Data
(60) Provisional application No. 60/410,144, filed on Sep. 12, 2002.

(51) Int. Cl. C02F 1/42; B01D 71/82

(52) U.S. Cl. 210/681

(57) ABSTRACT

An electrodeionization, (EDI) apparatus has flow cells with a sparse distribution of ion exchange (IX) material or beads. The beads extend between membranes defining opposed walls of the cell to separate and support the membranes, and form a layer substantially free of bead-to-bead dead-end reverse junctions. The beads enhance capture of ions from surrounding fluid in dilute cells, and do not throw salt when operating current is increased. In concentrating cells, the sparse bead filling provides a stable low impedance bridge to enhanced power utilization in the stack. A monotype sparse filling may be used in concentrate cells, while mixed, layered, striped, graded or other beads may be employed in dilute cells. Ion conduction paths are no more than a few grains long and the lower packing density permits effective fluid flow. A flow cell thickness may be below one millimeter, and the beads may be discretely spaced, form a mixed or patterned monolayer, or form an ordered bilayer, and a mesh having a lattice spacing comparable to or of the same order of magnitude as resin grain size, may provide a distributed open support that assures a stable distribution of the sparse filling, and over time maintains the initial balance of uniform conductivity and good through-flow. The cells or low thickness and this resin layers relax stack size and power supply constraints, while providing treatment efficiencies and process stability. Reduced ion migration distances enhance the ion removal rate without reducing the product flow rate. The sparse resin bed may be layered, graded along the length of the path, striped or otherwise patterned. Inter-grain ion hopping is reduced or eliminated, thus avoiding the occurrence of salt-throwing which occurs at reverse bead junctions of prior art constructions. Conductivity of concentrate cells is increased, permitting more compact device construction, allowing increases in stack cell number, and providing more efficient electrical operation without ion additions. Finally, ion storage within beads is greatly reduces, eliminating the potential for contamination during reversal operation. Various methods of forming sparse beds and assembling the stacks are disclosed.

### BACKGROUND AND RELATED ART

The present invention relates to electrodialysis, and particularly to apparatus and processes for filled-cell electrodialysis, also called electrodeionization, filled cell EDI, or simply EDI. In EDI, a plurality of fluid flow cells, typically long flat chambers, are defined between respective pairs of selectively ion-permeable membranes. These cells, include “dilute” cells through which a feed steam flows, alternating with “concentrate” cells positioned adjacent to the dilute cells for receiving ions removed from the feed stream. All cells are all arranged between a pair of electrodes, which are located at opposite ends of the stack or sequence of layers, and which provide an electric field oriented across the direction (and the planes) of the fluid flows. A packing of ion exchange material, typically ion exchange resin beads, is placed in the dilute cells to more effectively strip ions from the fluid as the fluid flows through the dilute cells, and this provides an ionically conductive medium for transporting the captured ions in the direction of the applied field. In the dilute cells, cations and anions present in the fluid flow are captured by the ion exchange material, and migrate, under influence of the applied electric field, in opposite directions across the (anion or cation) ion exchange membrane that bounds the cell, toward the corresponding electrode and into the adjacent concentrate cell. The ions are released into the concentrate cells, and are swept away by a concentrate or “brine” stream that passes through, or is recirculated through, the concentrate cells. The process removes ions from the feed stream during its travel through the dilute cells, yielding an output of substantially deionized or demineralized product fluid. EDI devices are operated with sufficient current so that ions locally present from water splitting continuously regenerate the ion exchange resin, maintaining its activity. The concentrate cells need not contain any ion exchange medium. They may also have a filling of ion exchange material, and/or they may simply accommodate a brine flow or circulation. In the latter case, a certain blowdown rate is maintained to prevent excessive concentration of the brine, which could lead to scaling, increase back-diffusion or otherwise decrease the purity of the product stream in the adjacent dilute compartments.

In some EDI systems, the concentrate cells also contain ion exchange beads, and functions of the compartments may be periodically interchanged by connection of the dilute and concentrate streams to the ports previously receiving the concentrate and dilute flows, respectively; and reversal of the electrode polarity.

The ion exchange material in the cells may be granular or fibrous and discontinuous, gel-like, felted or woven and somewhat continuous, may include granular matter held in a foam, felt or gel phase, or may have some combination of these characteristics. The ion exchange material generally has a composition that allows it to hold a significant amount of fluid, e.g., water, and the material may swell to overfill the electrodeionization compartments, so that it operates under a certain amount of pressure and serves as a mechanical support for the broad area membranes present on each side of the compartment. Such swelling assures that the cells do not collapse, and also provides good ionically-conductive contact between the membranes and the filling. Some manufacturers (Electropure, U.S. Filter) also or primarily rely upon the use of narrow cells defined by closely-spaced ribs to provide short membrane spans and/or additional membrane support, and to promote well-defined flows within the cells, essentially replicating multiple narrow cells to increase the overall capacity or scale of a stack. Uniform filling of the thin cells may be technically challenging, although some modular “envelope” constructions have long addressed this by simply designing the cells of an EDI stack as sealed modular compartment subunits, each compartment having several ribs or dividers forming a number of closed sub-compartments. By filling and assembling these sealed units separately on a special cell manufacturing line, the overall assembly of a stack may be effected by simply aligning a plurality of the preassembled cells or cell pairs in a stack, and securing them between two electrode and end plate assemblies.

In dilute or concentrate cells filled with ion exchange material, some of the ion exchange material is at least partially in contact with the membranes forming the walls of the cell. In dilute cells, the ion exchange material efficiently captures ions from the feed stream, and provides a stationary conductive medium through which ions captured from the fluid may migrate in the direction of the transverse electrical field. Wherever the exchange material is present, it also provides good conductivity through the cell or stack. Thus effective deionization may be carried out at a greater steady state current density and higher fluid flow velocity than would otherwise be possible. Notably, in filled-cell electrodialysis (EDI), the ion exchange resin presents a large area of fluid contact that effectively removes dissolved ions quickly from the dilute flow (in the dilute cells), or releases them into the brine flow (in the concentrate cells), while the transverse electric field operates to both move the ions transversely into the concentrate channels, and to regenerate the ion exchange functionality of the exchange material. The resulting EDI apparatus is highly effective, and, unlike beds of ion exchange beads, may be used to demineralize a fluid such as water without requiring periodic shut down to chemically renew the ion exchange medium. Removal of ions is quite versatile, and the feed fluid may be conditioned to even more effectively remove particular ions of interest. Moreover, the pH changes that may occur along the flow path due to selective ion depletion, polarized operation and other effects can enhance the ability of EDI to effectively remove species that are relatively insoluble at neutral pH, such as silica, without requiring extrinsic chemical additions to the feed stream. In such apparatus, the flow cells may achieve efficient deionization with relatively short interaction paths, for example, with a flow path through the cells on the order of a (0.1) to (1.0) meter long.

Several general EDI device architectures have come into use. One, a spiral-wound form, has variously layered membrane structures fitted into a cylindrical vessel and subjected to a radial electric field. Another is a rectilinear form in which a plurality of generally oblong-shaped flat membranes and spacers define a stack of dilute and concentrate flow cells, and the electrodes are placed at the ends of the stack. Disk-layered variants of this architecture have also been described. The principles of the present invention are applicable to all EDI devices, but for simplicity of discussion below, examples will be primarily discussed using the more common stack configuration.

The cells of a modern, general purpose EDI device are typically relatively flat or planar flow chambers, generally between about one-sixteenth and one-half inch in thickness (although much thicker cells have been used), and these may be assembled together with common inlet and outlet manifolds, in a “stack” or EDI assembly about one-half meter to about two and one-half meters wide (if stacked along a horizontal direction) or high (if stacked vertically). Stack construction permits parallel flow through many (e.g., 20-300 or more) cells, providing a high total flow treatment capacity. Other geometries, such as spiral-wound cylindrical EDI modules as shown in U.S. Pat. No. 5,376,253, employ similar membranes, exchange media, and electrodes deployed in a cylindrical/radial configuration.

Foams, felts, beads and fibers of ion exchange material have all been employed as a filling for EDI cells in various configurations; however most commonly, prior art commercial EDI stacks employ a granular ion exchange or bead filling, which may be a monotype, or may be a mixed bed of anion (AX) exchange resin beads and cation (CX) exchange resin beads (also called grains or particles herein). The resins may have strong or weak anion or cation exchange functionality, or may be mixtures thereof, and the type of resin may be varied to address particular feeds or the desired operating conditions or removal characteristics for a particular feed. In other embodiments, or in some layers of the stack, a single resin type (AX or CX) may be used, or the AX resin particles may form a distinct layer from the CX resin particles (a “layered bed”), or the AX and CX types may be laid down in different bands or zones along the flow path of the feed fluid and/or the concentrate stream (e.g., “zebra”, “sea island”, “striped”, or “banded” beds). These arrangements permit one to control local current, pH or other operating conditions, to control the regions or times at which particular ions are removed from the feed stream or appear in the concentrate stream; to control where and/or how water splitting occurs; and to control the environment along the various regions of a flow treatment path in the device. Resin selection and arrangement might also allow ion removal to be better tailored to the ion content or other characteristics of the particular feed stream.

Generally, EDI stacks constructed for high volume treatment of fluids, such as water or certain food components, have been found to operate effectively with resin beads large enough to form relatively permeable beds of low flow impedance, while still presenting a large surface area in contact with surrounding fluid. These beads are substantially larger than the powdered ion exchange media typically used in chromatography applications. The particles typically have a mean diameter of about 100-900 micrometers, usually about 300-700 micrometers, and most typically about 350-650 micrometers (ignoring, for clarity of description, the substantial dimensional changes that may occur upon regeneration or drying, or hydration, and the extremes of particle size distribution present in the many different commercially available resins.) With such bead dimensions, a filled two centimeter thick EDI dilute cell may contain a resin layer twenty to a hundred or more granules deep, while a three to ten millimeter thick concentrate cell would have a depth of about five to about fifty granules. The customary cell thicknesses and exchange bead sizes present a large active surface area for stripping ions and interaction with the fluid flow; allow the fluid to permeate along the direction of flow with a low or nominal flow resistance; and, in stacks configured for EDIR operation, allow a reasonably abrupt purging when the electrode polarity and dilute/concentrate ports are interchanged in a periodic reversal mode of operation. However, the exchange bead size, and the size relative to cell dimensions, impose certain limitations on the overall deionization process, and difficulties may arise in the process of filling the cells in the stack, or in maintaining a distribution or uniformity of cell filling over time, or in maintaining suitable flow impedance.

In general, it is desirable to control the rate of ion removal to enhance aspects of the EDI process. Often this is done by controlling the stack voltage, stack current, or the conductivity of portions of the stack flows, to prevent the occurrence of conditions such as extreme polarization, ionic overload of a portion of the flow path, or adverse ion interaction processes such as scale formation or deposition. The foregoing parameters may also be controlled to promote removal of specific ions, or determine the portion of the flow path where specific ions are removed. For these purposes, the mechanisms of electrical power usage or charge transport within an EDI stack are often treated as bulk processes.

On a macroscopic scale, however, the phenomenon of ion transport through a mixed ion exchange resin bed, from the feed fluid into the concentrate channels, proceeds by a discontinuous or segmented mechanism. An ion captured by an ion exchange (IX) granule migrates through the granule by Nernst conduction—ion migration driven by the transverse electric field—in the direction of the electrode of opposite charge. Ions travel through the grain until reaching the adjacent exchange membrane or a surface where the IX granule contacts the next IX granule. If this is an IX granule of opposite type (a “reverse junction”), then charge builds up, water polarizes and the ion picks up a hydronium or hydroxyl ion and is released into the surrounding fluid. In the case of such intermediate boundaries, the when the granule releases the ion, it picks up an available ion of appropriate charge, e.g., a hydroxyl or hydronium ion, while the released specie drifts in the surrounding stream until captured by the next available ion exchange bead of suitable type. Thus, the ion exchange beads in an EDI cell “throw salt” at reverse junctions. When the ion travels through a grain into an adjacent grain of the same ion exchange type, or through a grain at one boundary of the cell that contacts an ion exchange membrane of the same type, then it may be released directly into (i.e., the ion may simply continue its Nernst migration in) the adjacent exchange grain or membrane. Such transfer is electrically more power-efficient than the complete release into surrounding fluid and subsequent recapture by another grain, that occurs when ion travel by multiple releases at the boundaries between IX grains of different type, or release at a grain-water boundary. This is because continuous travel through contacting like-kind exchange media does not require a water splitting event to occur, hence does not require an excess of available electrons.

The mechanisms and efficiency of transport have been subject to a great amount of theoretical and empirical modeling, with the result that for available resins, appropriate proportions of uniformly-sized or known distribution anion and cation exchange granules, or resin bed dimensions or layer sizes may be determined for optimum operation, and the transport properties of beads having varying size distribution, as well as beds having different depths, are well understood (see, for example the solutions and modeling published by Vladimir Grebenyuk, 1965, and his later papers). However, in operation a number of generally acceptable designs have been found to suffer from problems such as localized heating, scaling, or irregular, locally excessive or deficient current distributions that contribute to such conditions or impair product quality. These have been addressed by approaches such as varying the resin mix or distribution, controlling voltage or current to be within certain operating ranges, and other techniques.

A typical filling, having low ratiometric or roughly comparable amounts of anion and cation exchange granules or beads in a mixed bed with a thickness ten or more bead diameters deep, provides for high flow or permeation, yet is able to assure that the flow of fluid contacts both anion and cation exchange granules to a sufficient extent that the ions present in the fluid are captured and removed to a high degree. However, these dimensional constraints necessarily result in a certain inefficiency of operation due to the above-mentioned discontinuous transport mechanism involving ion release and water-splitting at grain boundaries. They also result in a certain threshold level of residual ions in the product water due to the continual release at reverse-type bead junctions.

Other inefficiencies exist in typical current EDI stack designs. Conductivity and consequent potential differences may vary widely within the device. The loading of removed ions present in the resin is quite large, and when an EDI device is operated in a reversal mode, displacement and other processes may result in prolonged bleeding that can impair operation or require phased diversion of product or concentrate flows to maintain quality. Some efficiencies of operation of an EDI stack might be realized if the total ion travel distance could be made small, for example, by reducing the thickness of the dilute or concentrate cells. The ion migration distance to the nearest membrane of suitable polarity (in the dilute cell) would then be less, so ions would more quickly be driven into the concentrate channels and removed. Suitable field gradients could be produced by a lower driving potential on the electrodes, and with thinner cells, the number of cells in a stack could be increased and/or the total fluid through-flow could be increased. The potential applied to the stack could be reduced, or an increased electric field could be applied to raise ion transport velocity and reduce migration times further. This would also permit the linear flow velocity of the feed fluid to be raised.

However, reducing cell thickness is not a trivial change. The resin in a filled cell generally serves to assure a certain level and uniformity of ion capture and removal, of fluid (flow) impedance, and of dimensional spacing and support of the adjacent cell membranes. If thinner cells were to be used, such a change might require a finer resin so that the cell dimensions do not become small compared to the resin size and introduce unexpected changes in deionization effectiveness. Moreover, filling with smaller particles, such as filling of an assembled stack by flow-deposition of a particle slurry, or assembly-line filling of individual cell “envelopes” before assembly of the stack, may result in irregular or unanticipated segregation or sedimentation by resin type, or to complete blockage or irregular packing compared to larger cells with larger beads filled by conventional methods or transported in larger passages; or assembly of such a non-bulked device may prove to be too costly to produce a competitive device. Non-uniform distribution of resin or variations in internal flow can result in regions of excessive current, regions of low current, localized regions of extreme pH or concentrations of particular ions, and various scaling or related problems. Also, while simultaneously switching to smaller cells and resin particles might allow one to maintain a substantially uniform distribution of exchange resin in a smaller cell, smaller particles would have different hydrodynamic as well as exchange properties. They could increase the flow impedance, i.e., produce a more obstructed flow path, with smaller permeation spaces, greater fluid drag and higher back pressure. This would reduce the attainable flow rate for a given operating pressure, or pressure differential, and might possibly result in stagnation, polarization and scaling, or introduce other deleterious effects. Methods of effectively loading or distributing the exchange particles, retention of the particles in the cells without clogging ports, and other practical problems would also have to be addressed.

Indeed, the mechanical constraints imposed by ion exchange materials and the practical problems of manufacturing or assembly must be kept in mind. The construction of flow cells by large parallel sheets of ion exchange membrane filled with small beads may lead to pinching-off or bulging of the flow path, or the development of irregular filling or poorly-distributed (“channeled”) flow. This has been asserted by some suppliers, such as Electropure and Ionpure (now USF) to require constructions in which smaller well-defined channels are formed by subcompartments using long divider ribs bonded to the membranes. On the other hand, one manufacturer has proposed (in U.S. Pat. No. 6,379,518) that the compartments be quite thick, and that the EDI processes simply take advantage of the pH shift induced by the greater rate of migration of hydronium ions into the concentrate cells, to preferentially enhance selective ion removal; that scheme would exploit a sequence of non-neutral flows along local portions of the flow path. Others have proposed constructions with bipolar membranes or additional divider membranes to segregate stream within the device in ways that avoid scaling conditions or provide enhanced separation of recoverable components.

Within the overall architecture of EDI stacks as described above, the use of numerous different membranes have been proposed or employed, as well as exchange and other resins of different types or affinities, or resins and particles of mixed types, or specific types in different regions of a flow path. In addition, many different methods of operation have been proposed or employed to address selective removal of ions, to solubilize different components in the feed water such that they will ionize and be removed, or to address undesirable side effects that may occur due to water or membrane polarization or that may occur with particular feed waters. In addition to strict alternation of dilute and concentrating channels defined by repeating units of two membranes, various divided, staged or sub-channel arrangements have been developed that call for additional membranes or different (e.g., bipolar, impermeable, screen-like) membranes or separators to address particular applications or problems, such as the refinement or production of chemicals, the avoidance or mitigation of scaling or other undesirable events, the relative distribution of current at bead or membranes junctions, or the enrichment or selective depletion of acid, base or particular species.

The known constructions and variations of this type may be modified to address many specific EDI tasks with a high degree of effectiveness, from de-ashing whey, sugar syrup or other foodstuffs, to removing complex salts from radioactive or other wastewaters, to producing ultra high purity water from feeds with diverse matrices of starting mineral and organic impurities.

However, despite the ability of the technology to address a great range of problem fluids, an EDI stack is typically designed as a manufactured article, not a custom process, having an overall fixed arrangement of identical cells or channels substantially filled with standardized beds of bulk ion exchange resins and intended to operate in a steady state, or a small range of steady states, for a period of years. One desirable property of such a standardized article, given that the feed may be quite variable, is that it not be subject to unanticipated problems or deterioration in performance when faced with any reasonably anticipated feed or operating condition. Another desirable property is that the EDI unit achieve a high level of mineral removal. Yet another desirable property is that the unit be capable of shutting down and or restarting without requiring cumbersome or time consuming startup protocols or out-of-spec operation. Yet a further desirable property is that the unit be manufacturable in a cost-effective manner at a high level of quality.

There thus exists a continuing need for a basic construction that may be utilized in a range of applications, while resisting deterioration or adverse changes over a useful lifetime, and operating effectively in the field.

There also exists a continuing need for a basic construction that will achieve high levels of purification with reasonable utilization of power.

There also exists a continuing need for a basic construction that will achieve purification with low residual levels of impurity.

### SUMMARY OF INVENTION

One or more of the foregoing and other desirable ends are achieved by the present invention, which provides an electrodeionization (EDI) apparatus in which a flow channel or cell of low thickness has a spare, or sparse, amount of active resin, such as ion exchange (IX) beads or granules. The beads, which may be of one or more types, extend between membranes that define opposed walls of the cell, yet together they form ion conduction paths of short length with the adjacent membrane, and have an open packing, with a packing density well under 75% and in some embodiments in or below the range of 5% to 20%.

The cells of the device have a membrane-to-membrane thickness dimension, and corresponding height of the resin bed, such that the material loaded in the cell is substantially free of reverse junctions. A bed of beads may have a thickness less than several grains, and is preferably only one or two grains thick. The beads may be less than a layer, e.g., may consist of substantially sparsely-distributed single beads (that is, isolated or non-contiguous beads), or may have a distribution of grains that is thin; substantially a monolayer. Other embodiments have a bilayer of ion exchange beads, or a distribution wherein each grain has a limited number of neighbors. When the packing is a bilayer it may be an ordered bilayer, segregated by ion exchange type to include a thin or monolayer of cation exchange beads or material adjacent the cation exchange membrane, and a thin or monolayer of anion exchange beads or material next to the anion membrane. Most preferably the packing, layering or other configuration of exchange material is arranged so that it has few, or a negligible number of reverse junctions. Various methods of the invention produce such packings or distributions and provide enhanced processes for the overall fabrication of EDI units.

In one preferred embodiment, the beads lie in a single layer, and all or a substantial portion of the beads contact both membranes; the effective spacing between the opposed membranes is comparable to the nominal grain size, and may be, for example, between about one half millimeter and about one millimeter. With a monolayer or a layer of isolated non-contiguous beads, each bead may contact both membranes effectively; the lower modulus of bead and/or the membrane material in the wet state allows the beads to conform to the membranes at points of contact, thus increasing the interfacial area of direct membrane-bead ionic flow and enhancing the relative ion removal current and overall uniformity of current distribution over the area of the membrane. In embodiments when the layer is more than one bead dimension deep, the grains may be laid down sequentially or in strata; a preferred embodiment of this construction employs a substantially monolayer of anion exchange resin grains in the dilute cells contacting the anion exchange membrane, and a substantially monolayer of cation exchange resin beads deposited generally on the anion exchange beads and contacting the cation exchange membrane. This bilayer structure results in a distribution of grain-to-grain contacts in the sparse bed that is substantially free of the reverse junctions where ions of opposite charge could be released. In this bilayer construction and in the monolayer constructions, the bed does not throw salt, either in normal operation or when current density is increased, and the construction can therefore dependably operate to produce a product fluid of high purity under widely varying conditions. The construction is also expected to provide robust operation of the electrodeionization unit in which operating parameters may be dependably varied to accommodate different feeds or different stages of concentration without giving rise to adverse changes in quality of the product water, excessive or bolus release of stored/captured ions, or other adverse variations of operation. Assembly of the EDI stack may be facilitated by stabilizing the layers and bead distribution with a temporary or permanent adhesive. A screen mesh may also be provided within the cells to stabilize the bead distribution, and several embodiment advantageously employ a screen mesh to define one or more layers of the bead filling during preassembly fabrication.

In one embodiment, a flow cell of an EDI apparatus, such as a dilute cell, a concentrate cell or an electrode spacer cell, is defined between two ion exchange membranes with a cell thickness dimension below about three millimeters, advantageously below about two millimeters; preferably the cell thickness between inner faces of its bounding membranes has a spacing between about 0.3 and 1.0 millimeters. In one illustrative embodiment the thickness is approximately 0.5 millimeters. The cell holds a granular resin bed comprising anion exchange (AX) granules forming substantially a monolayer, or cation exchange (CX) granules forming substantially a monolayer, or both anion and cation exchange resin forming a structured layer. As described further below, the structured layer may be a substantially uniformly mixed monolayer or sparsely dispersed monolayer of mixed resin, or may a striped or banded layer having two or more regions of different ion exchange type, or it may be a graded layer that varies in ratio of the two ion exchange types along the length of the flow path. When the monolayer or sparse bead construction of the present invention is applied to an electrode spacer cell, preferably a monotype resin is used. Preferably the space between membranes holds a mesh or reticle that provides a distributed open support to assure a stable or relatively fixed distribution of the resin beads, and to maintain the initial balance over time between the competing requirements of good ion conductivity, membrane structural support or spacing, and good fluid permeation or through-flow. That is, the dilute cells contain a mesh or screen in addition to the beads. The mesh may have a lattice spacing comparable to or on the same order of magnitude as resin grain size. For example, the mesh may be a screen mesh whose strands define openings of between about 0.5 and 5 millimeters. The beads may be inserted in a mesh that elastically deforms to hold the bead, or may be sifted wet into a mesh sized such that wetted beads each adhere in a single mesh opening. This process efficiently provides a monolayer of sparsely distributed beads, with the mesh providing a lattice-work that may be loaded separately or loaded when it resides on the stack during assembly.

Alternatively, the beads may be sprinkled onto a mesh that has openings sized larger than the grain size, for example two to ten or more times the bead diameter, but sufficiently small to prevent bead migration or separation of exchange types, or sufficiently fine to assure that the resin, if it aggregates, nonetheless forms many relatively small dispersed clumps—i.e., remains a stochastically uniform but sparse distribution. This method of stabilization by the presence of a screen assures that the overall electrical conductivity of the cell remains good and uniform, and guards against the occurrence of unintended regions of pH variations or high polarization. The mesh may have suitable strand dimension or strength, and be made of suitable material to assure its mechanical robustness in use and compatibility with the requisite temperature and chemical environment and intended product water purity. The mesh may also have a weave or crossed filament structure that promotes turbulence or mixing to increase the effective contact of fluid in the cells with the exchange material in the cells and with its bounding membranes. For example an expanded mesh (having strips twisted with respect to the normal axis of the plane of flow), or a mesh having cross filaments alternately above and below the plane of flow, may be placed in the EDI cells.

The sparse resin construction described herein, wherein the cells are neither empty nor fully- or deeply-packed, permits a dimensional reduction of the cell thickness and of the resin ion-conduction path length, while maintaining membrane spacing and an open fluid flow path for effective deionization treatment. For example, the resin distribution enables effective flow through a cell of thickness dimension (along the direction of the applied electric field) under one millimeter, shortening the required ion migration distance and enhancing the ion removal/transfer rate. Sparse resin beds of the invention include layered, monotype, mixed-type, graded-type, striped or other beds of low thickness. The sparse distribution reduces or eliminates dead-end ion conduction reverse bead junctions and thus inter-grain ion hopping or salt-throwing; that is, it decreases the occurrence of ion release, drift and recapture that otherwise tends to figure prominently in the ion-transport mechanisms of the thicker resin beds which characterize the prior art in both steady state and dynamic conditions. Thus in EDI units of the present invention, release from the resin grains of an ion captured in a dilute cell occurs primarily or only at the grain-membrane contact surface rather than occurring multiple intermediate times at grain-water or hetero-grain boundaries characteristic of the thick bed cell fillings of prior art commercial EDI units. Both the electrical efficiency and stability of operation, and the total migration time for ion removal, are therefore enhanced, allowing new efficiencies in capacity and new modes of operation. Preferably, the filling forms a bilayer or a monolayer, so that once an ion is captured by the resin it travels entirely within a single bead to the cell-bounding membrane. Similarly, the concentrate cells achieve a desirable uniform or controlled conductivity, despite variations in the rate and type of ions removed along its length.

In one aspect, the exchange media in the cells may comprise substantially unpacked, incompletely-filled, or even substantially scattered or non-contiguous grains of ion exchange resin. For example, each grain may contact no other grain, or may contact between zero and three other grains, rather than forming a so-called packed bed filling. In a packed bed, the packing or percentage of space occupied by solid beads is determined solely or largely by the grain size or distribution of grain sizes, and is generally above about 60% or even 80%, with all beads except those at the membrane contacting many neighboring beads. For example, in a conventional thick resin bed of uniform spherical beads, a hexagonal packing is naturally assumed, wherein each bead has over about ten points of bead-to-bead contact, defining a fairly tortuous interstitial space for permeation of the feed amounting to under 20% of the cell volume. The present invention, having beds less than two grains deep, has a packing density significantly lower, and presents appreciably more open flow or permeation space. In stacks employing sparse media in the dilute cells, the concentrate cells may be entirely empty of exchange media, and may have simply a screen spacer to maintain the desired membrane support and permeation space, or they may also contain a sparsely distributed ion conductive medium. In EDIR (EDI reversal) embodiments the dilute and concentrate cells may be substantially similar.

In one embodiment of the invention, an EDI cell includes a sparse distribution of ion exchange granules beads, the grains being scattered or otherwise distributed over the surface of a flow cell membrane and sandwiched between that membrane and the adjacent membrane to provide ion-conductive posts or supports between the two membranes. The grains support and maintain the membranes spaced apart, providing an open flow percolation space within the flow cell between the membranes. In a further embodiment of the invention, an EDI cell includes a sparse distribution of exchange granules, and the cell also contains a screen, with a mesh size at least as great as the bead size. Beads are thus positioned in openings of the screen, while the filaments defining the screen pass adjacent to beads, “fencing” the beads in fixed positions. The mesh may be a bi-axial or lattice-like filamentous screen mesh that extends entirely across the EDI channel or flow cell. The resin beads are restricted from migration by the mesh, and with larger mesh size and higher amounts of bead filling, the beads may also be partially supported vertically, forming layers about 1½ to 2½% beads high with good bead-to-membrane surface contact and stable distribution. The mesh may be a screen formed of crossed fibers, with first fibers extending along a first direction and lying substantially in a plane parallel to the cell membranes, and second fibers crossing the first fibers at an angle and lying substantially in a second plane that is parallel to the first plane. Alternatively, the mesh may be formed with all fibers lying in a single plane, or may be a woven mesh with an over/under weave so that the fibers run obliquely alternating upwardly and downwardly from membrane to membrane. In some embodiments, the mesh is a rectangular or square mesh oriented on a bias; that is, both the first and the second fiber directions are transverse to the nominal direction of bulk flow of fluid through the cell, for example at a +/−?/4 angle to the nominal direction of the flow path. The fibers forming the mesh may lie in first and second planes at different heights or levels. The fibers then form a lattice of segments extending like criss-crossed rail fences in the channel, defining a reticulation of small corrals. The corrals segregate and support the granules so that they form a bed that may pile-up more than one grain deep, for example averaging 1.3 or 1.5 nominal grain diameters deep, but the beads remain uniformly distributed in a statistical sense, over the area of the flow cell. The plane(s) of the fibers may be positioned such that the height from a fiber to an adjacent membrane is comparable to or smaller than the least resin grain size, so that resin particles cannot move over the mesh (“hopping”) or under the mesh (“crawling”) during fluid flow once the cells have been filled. One or both sets of fibers may undulate, effectively filling the nominal cell height such that the screen forms a compliant spacer between opposing membranes with cross fibers that effectively restrain the ion exchange beads from drifting. Thus, in use, the resin particles do not drift into pockets or banks that might impair electrical conductivity through the cell at some points, or impede the fluid flow, but instead remain well-dispersed, contacting and supporting in spaced-apart relationship the membranes that comprise the walls of the cell. In larger-scale embodiments, for example, in embodiments where one or more sets of cells are thicker than about one millimeter, the use of a screen having fibers extending at different heights within the cell may also be configured to facilitate fluidized filling of the cells with resin after stack assembly. For example, when filling with a fluidized flow via one or more passages, as shown, for example, in commonly-owned U.S. provisional patent application Ser. No. 60/354,246, filed on Feb. 2, 2002, the transversely extending oblique fibers or rails of the screen may have an orientation and gap effective to guide the injected fluid bead slurry outwardly from the filling port across the length and width directions of the cell, to disperse and distribute the filling entirely over the area of the cell. By using a thin slurry and interrupting it with air pulses during the filling procedure, beads may be uniformly loaded in the cells while avoiding voids and preventing settling or separation of the resin types during the fluidized transit. However, as discussed in greater detail below, preferably resin filling is done prior to stack assembly.

One preferred embodiment of the invention is a stack with symmetrically-dimensioned dilute and concentrate cells, each holding a sparsely distributed exchange media The stack may be assembled of many pairs (for example, 100-300 pairs) of such cells, and the stack of cells is configured to operate in a reversal mode (EDIR). The small thickness dimension of the cells, and the mesh when present, provide a well-defined and relatively low flow impedance that results in a low but well-defined transit time through the cells. Thus, for non-viscous fluids such as water at normal temperature, or for more viscous fluids such as syrups and extracts at higher temperatures, the thin cells provide enhanced treatment capacity and space utilization. The greatly reduced cell thickness allows a dimensional reduction of the stack as a whole, so that half-height EDI units, or several units assembled in a single stack may be constructed, allowing flexibility in overall treatment system design. Suitable manifolding may be provided to constitute a two-stage EDI stack, and the brine or feed paths as well several operating characteristics may be separately controlled in each stage. Moreover, since the construction reduces or eliminates the bead-to-bead reverse junctions of prior art constructions, great current variations may be accommodated without throwing salt, scaling or lowering the product quality. In EDIR operation, the feed and brine fluid valves may be operated with a phase delay with respect to the valving of fluid inlets or electrode operation, as shown in commonly owned U.S. Pat. No. 4,381,232. Moreover, operations may be carried out, such as cleaning on the brine side during reversal as discussed further below, without contaminating product. This extends the range of EDI stack processes, so that an EDI stack may be safely operated with many new feed fluids, or may be extended into new areas of application, e.g., to pharmaceutical or food industry processes.

Alternatively, stacks in accordance with the present invention may have a construction wherein cells of one type, such as dilute cells, have a conventional thickness in the range of one-eighth inch to several inches, while the adjacent cells (e.g., the concentrate cells in this example) have a monolayer thickness or sparse bead distribution. This construction may be readily implemented by a modification of, for example, the construction employed in a commercially-available stack of the type having its dilute cells formed as sealed discrete filled envelope units having a cation exchange membrane and an anion exchange membrane sealed to opposite sides of a dilute spacer, and filled with mixed beads. Some existing commercial stacks of this type, for example, form concentrate cells by simply placing a spacer (a “concentrate spacer”) between each pair of the sealed dilute envelopes. The concentrate spacer may be formed as a simple polypropylene or other sheet-like gasket, with a solid perimeter region and an open central region holding a screen spacer. The gasket portion, which may be injection molded about the screen portion, provides a strong structural wall of precise thickness, while the screen portion serves to prevent the membranes from closing off and contacting each other, maintaining an open flow or permeation channel for the concentrate flow. Such existing commercial devices may be modified in accordance with this aspect of the invention to have a monolayer or sparse filling in the concentrate chamber. This may be accomplished by simply pushing ion exchange beads into the screen openings; the screen fibers deflect slightly to resiliently hold the beads in a sparse monolayer, and the bead-loaded screen/gasket unit may then be dependably lifted, moved into place on the stack, and assembled. Thus the concentrate cells may be very simply and dependably filled in the course of stack assembly by simply adding beads to the concentrate screen. Such prior art commercial stacks may have molded spacers with integrally-formed mating perimeter grooves and ridges, as well as mating registration pins and apertures, on the various spacers that allow the units to be reliably stacked and pressure-sealed in a well-aligned, leak-free assembly. By placing a concentrate screen/monolayer between each pair of sealed dilute cell units, the conductivity of the concentrate cells is sufficiently high to provide substantially immediate operation at an effective level to produce a low conductivity product, without lengthy start up, concentrate flow adjustment or salt injection. Moreover, the concentrate cell conductivity is made substantially uniform over its area, so that the potential applied across the dilute cell and the resistance of the stack as a whole are both well-controlled. Reference is hereby made to commonly-owned U.S. Provisional Patent application Ser. No. 60/398,954, filed on Jul. 26, 2002 for further details of construction regarding sparse bead modifications for concentrate cells of stacks formed with pre-filled dilute cell envelopes. That United States provisional patent application is hereby incorporated herein in its entirety.

The invention also includes methods of making EDI stacks as described herein, and various methods of distributing ion exchange material in cells of an EDI device.

Thin cell or sparse bead EDI stacks of the invention may have exchange media placed therein as the cells are assembled. In one method of assembly of a sparse bead EDI stack, the resin is added in the cells by positioning a first membrane of a cell to define a central interior region (e.g., the active chamber of a dilute or concentrate cell, for example the chamber defined by a perimeter spacer body a central cut-out or open region). Resin particles are then sprinkled onto the membrane and a second membrane is placed on the spacer to close the cell. Another spacer is positioned on top of the second membrane and these steps are repeated to fill and form the next cell of opposite type, e.g., a concentrate cell. When filling the dilute cells so constructed, a desired quantity of the exchange beads may be sprinkled as a first layer of one type, followed by sprinkling a second layer of different type, forming a two-layer bed. In this case, the first layer may predominantly contact the first membrane, and the second layer may be deposited over the first layer so that it will predominantly contact the second membrane. Alternatively, the resin may be applied as a layer a single bead deep, or may be applied as a sparse layer of substantially non-contiguous, isolated beads. In these cases, the layer may be of mixed composition, or otherwise contain exchange material of both anion exchange and cation exchange types. In addition to uniformly mixed resin fillings, the filling may be one that changes in relative proportion of materials. For example it may be applied from a source of graded composition, or may be applied from two separate sources (such as nozzles or hoppers) that are controlled to release varying amounts of the different resins as they travel along the length of the cell, to form a deposited bed of exchange material that varies from a pure AX resin or AX-enriched mixture at region or one end of the flow path to a pure CX resin or a CX-enriched resin at another region or the other end of the flow through the cell, or vice-versa. A mechanical assembly to carry out the resin distribution may include a sprinkling mechanism, for example, it may include one or more components to promote resin distribution, such as a screen sifter that imparts some component of movement to the beads as they are sprinkled at a defined rate onto the membrane, a chimney that confines the sprinkled beads as a falling stream directed onto the desired region of the underlying membrane while randomizing the bead distribution through kinetic (collisional) redistribution as the beads fall, or a patterned (e.g., printed, stenciled or sprayed) adhesive on the membrane that simply retains the desired monolayer as beads are cascaded against the membrane surface. When such an adhesive is employed in the filling process, the adhesive may be an EDI-compatible permanent adhesive, or may be a temporary adhesive that is selected to be carried off after start up (such as a starch), or during an initial cleaning cycle (such as in an acid or caustic cleaning regimen). The resin type applied during deposition in the cell may be controlled in some embodiments to form bands or stripes of different resin type changing in level or volume ratio along the direction of flow through the cell.

In some embodiments, a screen or mesh is used to fix or constrain movement of the filling. Such constructions are especially preferred in sparse fillings, and most preferably when the filling is constituted by a bed of isolated or non-contiguous beads of exchange material. Unlike conventional EDI mesh constructions wherein a screen serves essentially as a spacer to maintain an open flow path while separating the cell membranes by a defined distance, the fibers of the mesh, forming the edges of each small corral, are effective to segregate the resin particles in the cell against migration. When the layer is more than one bead deep (for example when it is between 1 and about 2 beads deep), the screen filaments may also function to support the resin particles. The packing density is relatively low-well under 80%, and may be relatively uniform at a level of about 40% to about 65%, when a mono- or bi-layer is used, and as low as 15-20% when a sparse layer of non-contiguous beads is used. Use of a screen with a small open lattice to support and/or restrain the particles allows granular beds less than a few grains thick to be dependably formed and robustly maintained in position. Because the filling has relatively few grains, an open (highly permeable) packing is obtained and good membrane contact may be achieved even when inexpensive ungraded ion exchange resins with a wide particle size distribution are employed. With uniform size resins, strict monolayers may be readily achieved, while with resins having Gaussian, multimodal or broad particle size distribution, mono- or bilayer thickness may be dependably achieved in cells up to several times the mean particle dimension while achieving and maintaining a stochastic uniformity in distribution of the sparse filling.

In operation, when fluid flows through the EDI cells so constructed, the presence of the mesh fiber segments extending in different directions and/or different level of the channel further serves to deflect flow across the thickness dimension of the cells in a serpentine fashion, enhancing fluid shear effects for ion capture and removal at both the cation and anion membrane sides of the channel. In general, the presence of single exchange beads directly contacting and supporting the membranes results in a construction in which each bead acts as a “pillar” in the flow path that both supports the membrane and provides unidirectional ionic conduction to one or the other adjacent membranes, e.g., of like ion exchange type (in the dilute cells) or a uniformity of current flow (in the concentrate cells).

In another general form of construction, the EDI apparatus of the invention is configured as a spiral-wound EDI module rather than a stack. In the spiral embodiments, the dilute cells, concentrate cells or both are configured with a sparse filling of exchange material as described above. Modules in accordance with the invention may be readily manufactured in spiral form, and the thin cells so constructed allow a large number of spiral windings to be achieved in each module while assuring a uniform current distribution free of voids and hot spots at which malfunction such as blockage, scaling, or other undesirable operation contributing to malfunction, aging or premature failure might occur. Advantageously, for such spiral module constructions, great manufacturing efficiencies are achieved. The ion exchange membrane may be covered with a coating of beads as a bulk coating process in a continuous run, and cells may be formed by edge-sealing the membranes to form one long closed envelope. One or several of the envelopes so constructed may then be wound and closed in a cartridge. Thus, spiral modules may be assembled from a coated membrane which carries sparse bead, sandpaper-like, on its surface, forming cells as spiral-wound envelopes communicating with respective dilute and concentrate manifolds. The electric field is established radially, e.g., between a center electrode and a circumferential electrode as in the prior art, and the center electrode may comprise a pipe that also constitutes the supply or the brine manifold. Constructions may be configured for axial or radial flow.

Sparse fillings of the invention may be implemented with only the concentrate cells, or only the dilute cells having a sparse bead distribution. In that case, the cells of opposite type (dilute or concentrate) may be like those of prior art EDI devices—e.g. with thicker and bead-filled dilute cells, or with empty concentrate cells or with thicker and bead-filled concentrate cells (with or without a screen spacer). In units of the invention, when both dilute and concentrate cells are to have a sparse bead distribution, the dilute cells and concentrate cells need not have the same type of bead filling. For general demineralization applications, it is generally preferred that the dilute cells include exchange resin of both types, either mixed, or layered or in a sequence of stripes. However, some embodiments of the invention may have monotype exchange resin in the dilute cells to effect or enhance the removal of particular ions and/or to provide substantially acidic or basic streams during all or a portion of the processing. In a number of embodiments, the concentrate cells may have a single type of resin, and the resin may be selected to have a specific strength or quality in view of the fluid processing. By way of example, an anion resin may be used in the concentrate cells for enhanced resistance to scaling, or a cation resin may be used for particular fluids for which its resistance to oxidation or to degradation by chlorine is advantageous. These properties are also advantageous when used near the electrode chambers, so such single-type resin may also be used in the catholyte or anolyte cell or proximate portion of the stack. Similarly, a monotype resin may be selected for use in concentrate cells for enhanced conductivity, heat resistance or other property. It is also not required that all cells of a given type be sparsely filled; a unit may employ a first set of cells of conventional thickness and filling, and a second set of cells having a sparse filling.

### BRIEF DESCRIPTION OF DRAWINGS

The invention will be understood from the description and claims herein taken together with the drawings showing details of construction and illustrative embodiments, wherein

FIG. 1 schematically illustrates a typical EDI apparatus and cells of the prior art;

FIG. 1A illustrates details of water splitting, desalination and recontamination in a dilute cell of the apparatus of FIG. 1;

FIG. 2 illustrates a cell of an EDI apparatus having a sparse resin distribution of the present invention;

FIG. 2A shows an enlarged detail in cross section of a bi-layer embodiment of the cell of FIG. 2;

FIG. 2B shows a schematic and exploded perspective view of one embodiment of a stack having cells of the invention;

FIG. 3 illustrates a bi-layer embodiment employing a screen;

FIG. 4 shows an enlarged detail in cross section of a monolayer embodiment of the cell of FIG. 2;

FIG. 5 shows an enlarged detail in cross section of a mixed resin monolayer embodiment of the cell of FIG. 2;

FIG. 5A shows an enlarged detail in cross section of a mixed resin three-layer embodiment of the cell of FIG. 2;

FIG. 5B shows an enlarged detail in cross section of a mixed resin four-layer embodiment of the cell of FIG. 2;

FIG. 5C shows an enlarged detail in cross section of a mixed resin multi-layer embodiment of the cell of FIG. 2;

FIG. 6 shows an assembly with moving vibrated sieve for depositing sparse resin distributions for EDI stack assembly in accordance with the present invention;

FIG. 7 illustrates a dispenser assembly for effecting sparse cell filling with multiple exchange resins in accordance with the present invention in accordance with the present invention; and

FIG. 8 illustrates a distribution tower for depositing exchange resin in a sparse distribution in a spacer for fabricating EDI devices of the invention;

### DETAILED DESCRIPTION

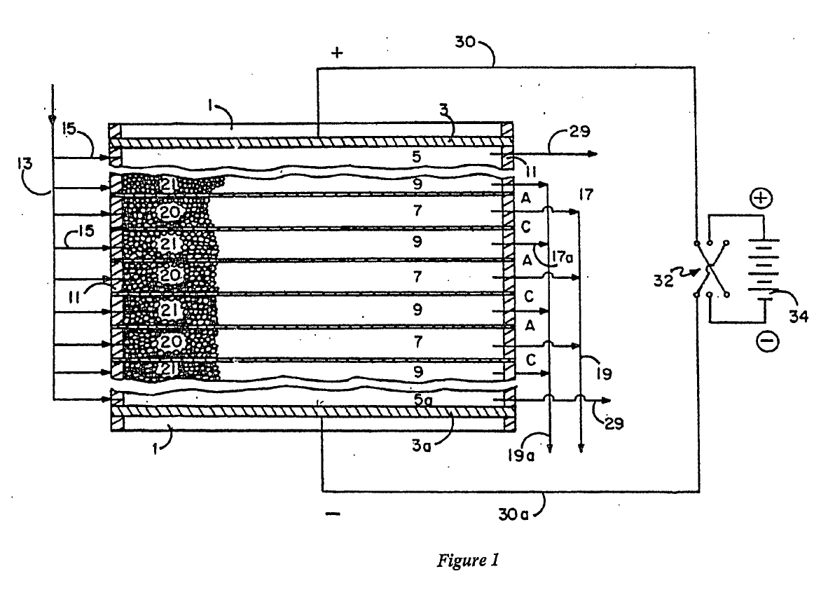

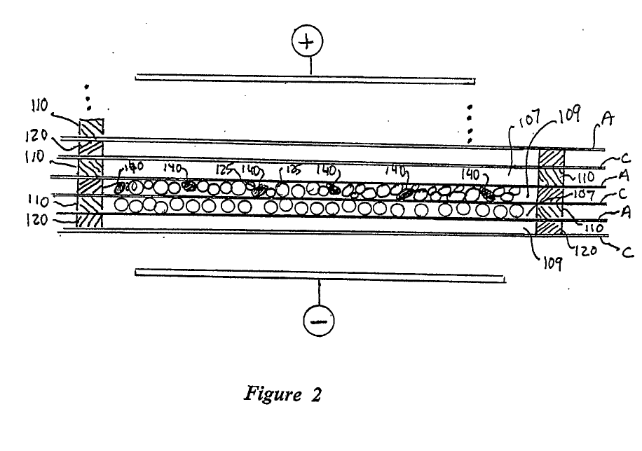

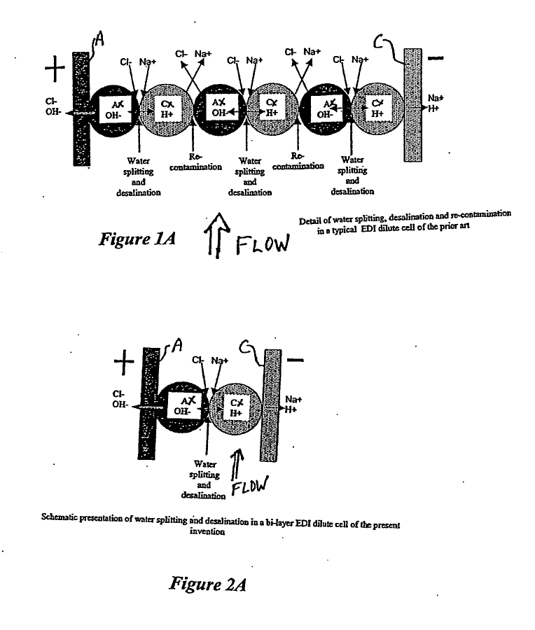

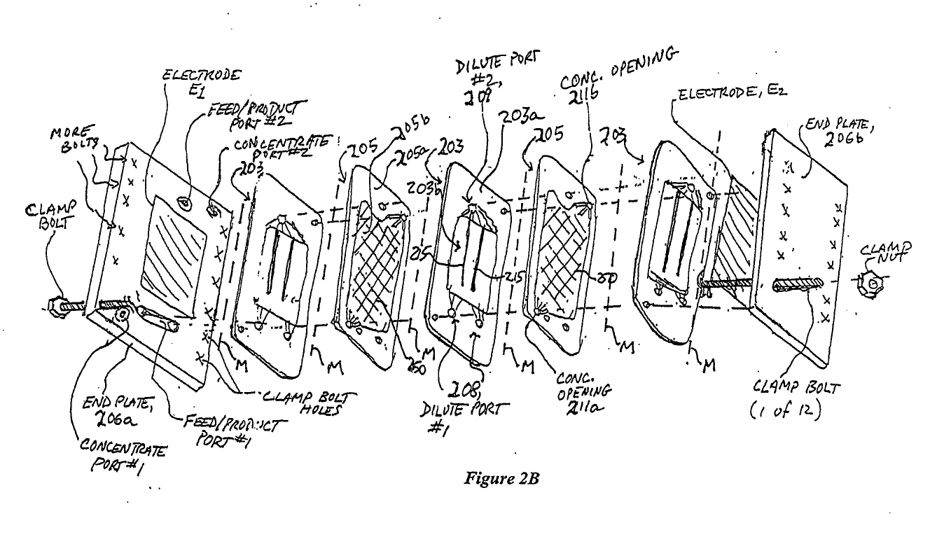

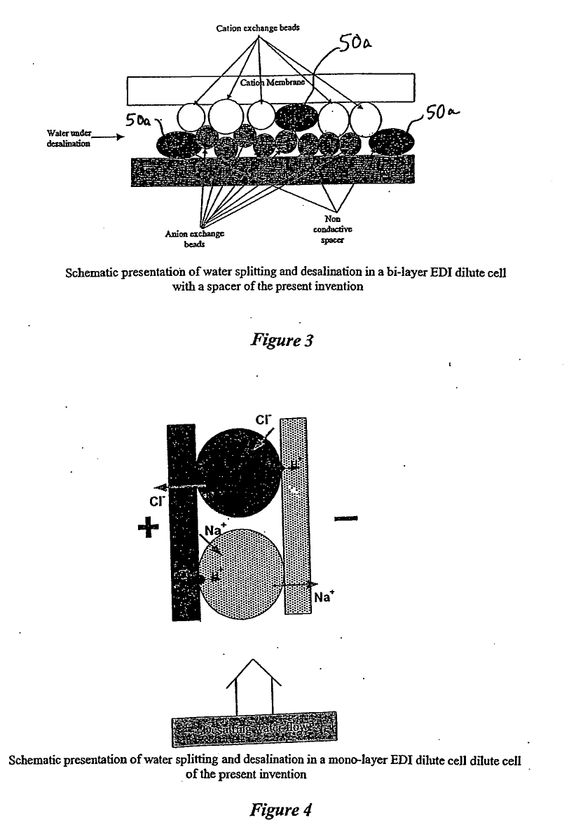

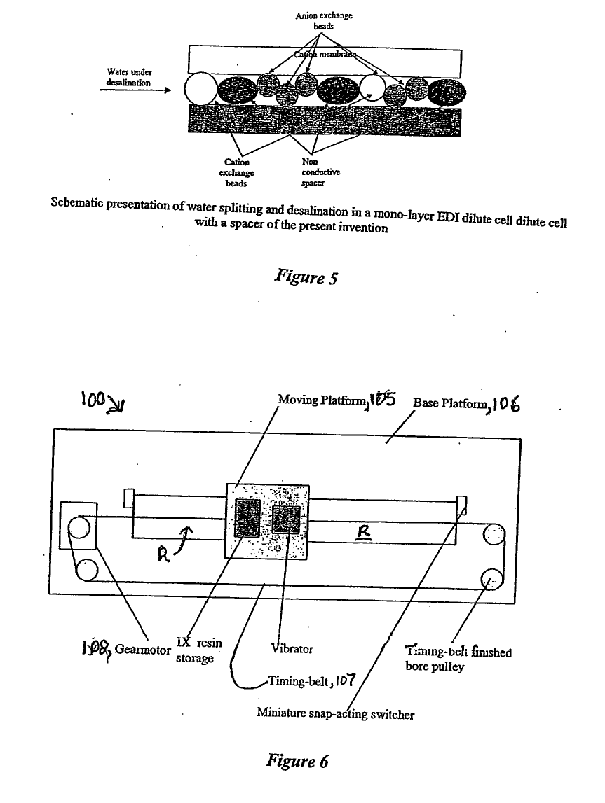

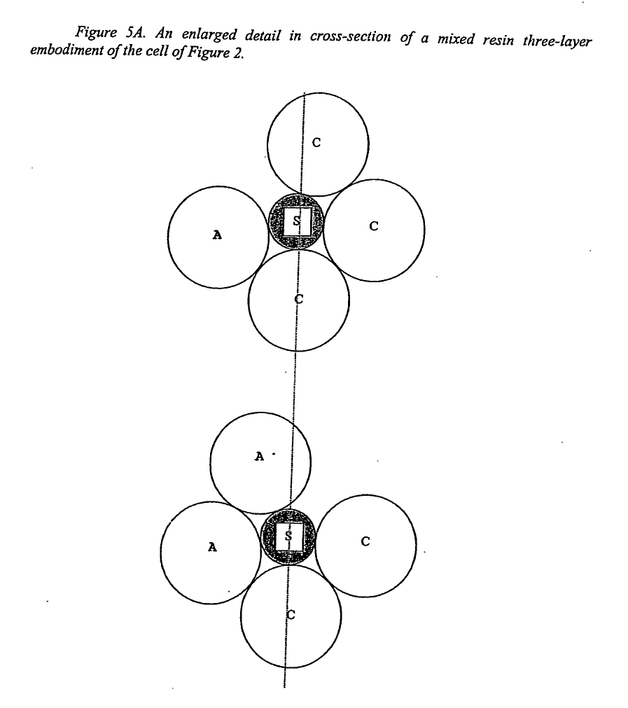

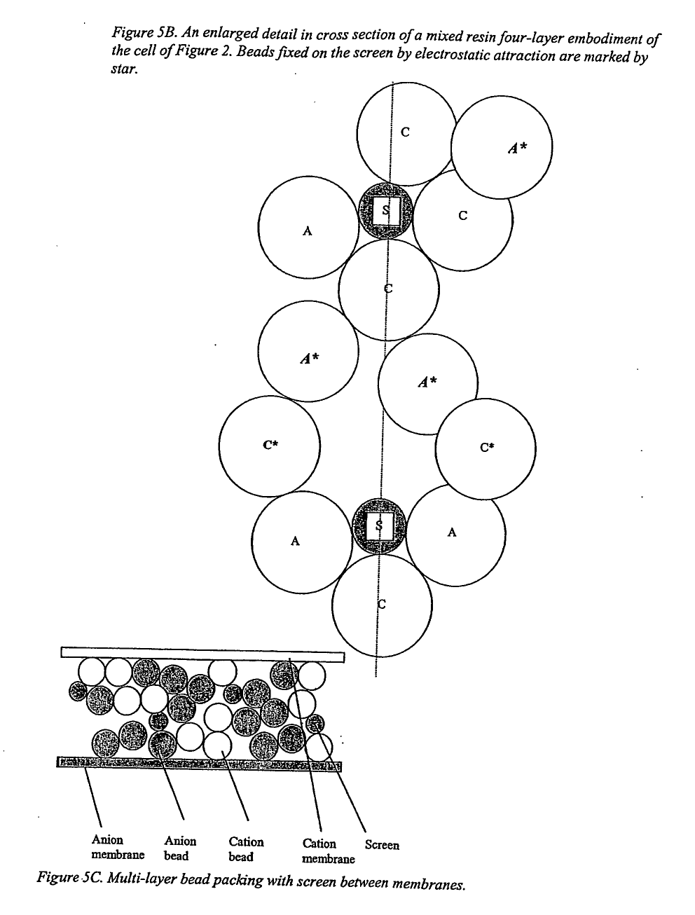

The invention will be better understood following a brief description of typical methods and relative dimensions involved in construction of prior art EDI units. A multi-cell electrodeionization (EDI) stack of the prior art is shown in FIG. 1, illustratively a stack-type electrodeionization reversal (EDIR) unit, to illustrate the general construction of such stacks and various elements to which the improved configurations of the present invention may be advantageously applied. As is well known, such deionization devices may be fabricated with a great number of different sizes, shapes, operating procedures, membranes and fillings. It will be apparent following the discussion below, that any of these, both for EDI and for EDIR systems and structures other than those shown, may also be modified in accordance with the present invention. Moreover, it is understood that the configuration of membranes, ion-exchange filler material and chambers arranged between electrodes of a unit may be modified in various known respects without departing from the principles of the invention, described more fully below in relation to FIGS. 2-9. Moreover, while the illustrated unit is a stack, the invention is also applicable to other EDI architectures, e.g., to spiral-wound cartridge constructions. Thus, the description of FIG. 1 is schematic, for background purposes only.

FIG. 1 illustrates an EDI apparatus for demineralizing a feed fluid. The specific device includes manifolds or conduits for passing solution into and out of the unit in various directions, and employs the principle of periodic reversal of the direction of the direct current. The illustrated EDI unit comprises first and second electrically insulated end plates or walls 1, a first electrode 3 connected as an anode and a second electrode 3a connected as a cathode. The electrodes are disposed in electrode chambers or compartments 5 and 5a, respectively, through which suitable flow of electrolyte is maintained. A number of first ion selective membranes C that are selective of cations are alternately placed with second membranes A selective of anions in a stack extending between the two electrode chambers and each membrane has ion exchange functionality that allows it to conduct ions, such that the membrane selectively permits passage of positive or negative ions, respectively, in direction of the electric field applied between the anode and the cathode. Each pair of adjacent membranes is separated by a spacer 11, and the spacers have an open central region, so the membranes subdivide the space between the two electrode chambers into adjoining chambers or cells which are alternately of two types 7 and 9, now commonly referred to as dilute cells (7) and concentrate cells (9). The dilute cells are those in which the membrane A is on the anode side of the cell and the membrane C is on the cathode side, so that ions will be transported from the cell toward the respective electrodes into the adjacent cell. The concentrate cells lying on both sides of each dilute cell have the opposite membrane configuration, effectively preventing the ions that they receive through the membranes from progressing any further toward the electrode, so that the ions reenter the fluid stream in the concentrating chambers.

In conventional EDI stacks, the gasket-like or chamber-defining spacer members 11 are typically between a small fraction of an inch and about an inch thick, and have a solid perimeter wall region of defined wall thickness circumscribing an open interior region which constitutes the flow cell, 7 or 9, between the adjacent membranes. The manufacture and properties of cation-permselective membranes is disclosed in U.S. Pat. Nos. 2,702,272, 2,730,768, 2,731,408, 2,731,411 and many others; similarly, anion-permselective membranes are disclosed in U.S. Pat. Nos. 2,730,768, 2,800,445, 2,860,097 and many others. The membranes may be heterogeneous, formed by extruded mixture of ion exchange powder held in a binder, or may be homogeneous membranes in which the body of the membrane itself is formed of a suitably exchange-functionalized polymer material.

In EDI units, the ion-diluting chambers 7, ion-concentrating chambers 9, or both, contain therein a fluid permeable filler or bed 20 and 21 of granular, spherical or fibrous or other ion-exchange media which operates to strip ions from the fluid stream and greatly increase the effective rate of ion removal. The exchange filling is typically an intimate mixture of strong anion and cation exchange media, or of various strong and/or weak exchange media, and may optionally include certain other resin beads or media to modulate impedance, capture specific impurities or foulants, or effect other functions, as appropriate to the intended process or application (see, e.g., U.S. Pat. Nos. 5,066,375, 5,120,416 and 5,203,976 and others). The exchange and other media are generally selected from a large number of ion exchange resins and treatment media that are commercially available for use in ion exchange beds in food processing, power, or other industries for purposes such as demineralizing, sweetening, clarifying or decoloring, and the like, and are typically polmers, that may include resins with a gel, macroporous, macroreticular or other matrix having desired operating characteristics. Anion exchange resins incorporating a quaternary ammonium type of structure, cation exchange resins comprising a sulfonated copolymer of styrene and divinylbenzene, resins having strong or weak basic, or strong or weak acid functionality, and resins having a great range of effective cross linking, water content or transport properties and various types of physical strength or environmental resistance to degradation are readily available from numerous companies including Dow, Rohm & Haas, Purolite, Sybron and many others throughout the world. The fillings may be mixed by weight, proportion or activity, or may be segregated in layers (across the ion transport direction), bands or stripes (across the fluid flow direction), or treatment regions along portions of a stage or the like.

In the illustrated electrical state of the EDI apparatus shown in FIG. 1, the polarity of the direct current field source is connected such that the electrode located on the top side of the drawing is anodic or positive, and the electrode located at the bottom is the cathode or negative electrode. There is thus defined between the anode and the cathode a plurality of intermediate chambers comprised of ion-depleting (fluid-desalting or diluting) chambers 7 and ion-enriching or concentrating chambers 9. Feed liquid may be supplied to the chambers by a common manifold inlet 13, illustrated schematically, which couples to ports 15 entering each chamber. In modern practice, the manifold and conduits may be provided by simple aligned supply and return openings that pass through the solid regions of the entire stack of membranes and spacers A, C, 11, rather than utilizing discrete connectors to each cell. The feed, product and concentrate inlet and outlet conduits are then formed, entirely or in part, by apertures passing through the spacers and membranes which align to form through-conduits when the spacers are urged together in a stack. The spacers forming each type of cell—dilute or concentrate—may have lateral channels, grooves or other passages extending between the central cell region and the aperture that supplies that cell, so that a given set of aligned apertures in all spacers opens selectively into only the dilute cells, or only the concentrate cells to place them in communication with a corresponding port at one or more of the end manifolds. Various forms or bead retainer may form screen, fibrous or comb-like barriers to retain the filling and prevent resin loss or migration.

Generally, a feed solution to be treated may be passed into the electrodeionization reversal (EDIR) unit continuously or batch-wise, in series, or in parallel flow, or in various other ways that are well known in the art. For example, the concentrate chambers may be fed by a recirculating brine concentrate loop, by a lower volume bleed from the feed, or by a bleed from the demineralized dilute product (i.e., the flow of feed which has passed through the dilute cells). The direction of fluid flow in the concentrate chambers may be the same as the flow direction of the dilute chambers (co-current flow), or may be opposite to the flow direction of the dilute chambers (counter-current flow). When the feed solutions to the chambers 7 and 9 are dissimilar in salt concentration or when they are comprised of different liquids, or require close pressure of flow regulation, a separate manifold may provide the inlet connection for each type of compartment so that one set of compartments 7 is fed from a first manifold and the other set 9 by a second manifold. When configured for use in an EDIR (reversal) mode, a stream reversal mechanism, such as a multiport hydraulic reversal valve (not shown), is also provided. The valve may, for example, operate to interchange the two different fluid streams, diverting the diluting feed stream from one set of chambers to the alternate set of chambers during two cycles of operation, and in a coordinated (and generally phased) fashion, diverting the concentrate feed stream in the exact opposite manner. Similarly, combining valves may direct the diluting and concentrating effluents to desired downstream locations (such as to a product, waste, or holding tank, or to drain). In both cycles, the flow to the electrode chambers may also be reversed or interchanged, so that, for example, the former anode (presently the cathode) is flushed with a stream of electrolyte solution and the former cathode (presently the anode) may have another liquid flow therethrough. In this case, an electrode structure is provided that is suitable for either anodic or cathodic operation. This may require a special titanium or platinized electrode structure, or other relatively costly electrode (that might otherwise be employed only for the anode) to be used for both the anode and the cathode.

As the solution passes through the chambers of the electrodeionization reversal (EDIR) unit, the ions present in the diluting chambers 7 are removed from the feed stream by capture at surfaces of the exchange resin filling and migrate by ionic conduction through the resin and adjacent membrane, transferring the removed ions in accordance with their charge polarity into one or the other of the adjacent concentrate chambers 9. The resulting purified dilute stream passes via conduits 17 into a common discharge or product outlet manifold 19. One or more electrolyte outlets, such as outlet pipe 29 may be employed to remove liquid (and gas) from the electrode chambers 5 and 5a. In various known systems one or more of the electrolyte streams may be applied to achieve additional functions, such as to condition the pH of the concentrate or other flow. Similarly, the solution supplied to the second set of chambers 9, which in the illustrated EDIR state would be the ion-concentrating chambers, will pick up ions that migrate into chambers 9 from the diluting chambers 7. This concentrating salt solution passes from the concentrating chamber via conduits 17a to a common discharge manifold 19a. Solenoid valves (not illustrated) are electrically connected and their operation coordinated in relation to the polarity reversal switch to allow the solution passing out from each set of chambers to be collected, or, in the alternate, to be directed for example into other chambers or processes. Electrode leads 30 and 30a connect the electrodes, via polarity reversal switch 32, with a source of direct current 34. For clarity of exposition, the drawing omits the usual pumps, flow restrictors, rotameters or valves which, as understood in the art, may be employed in conjunction with such an electrodeionization reversal (EDIR) unit in a treatment system.

For completeness, note that prior art EDIR units may be modified in design in several ways from the simple system described above. One such modification is “internal staging” whereby the effluent solution of one set of diluting and/or concentrating chambers is passed as the influent feed to a subsequent set of diluting and/or concentrating chambers that are located within the same electrodeionization reversal (EDIR) unit and between one pair of electrodes. Such a set of diluting and concentrating chambers is termed a “hydraulic” stage and the apparatus can combine a plurality of stages between two end electrodes. Another variation is to insert intermediate electrodes between two of the stages. The electrodes may be connected in common, and the two stages may be hydraulically fed from a flow distribution block placed in the middle of the stack, e.g., between the intermediate electrodes, such that electrical current will flow in opposite directions through the adjoining electrical stages between the end electrode of one charge and the intermediate electrode of opposite charge. More than one hydraulic or electrical stage, or combinations thereof, may be used within a single EDI/EDIR stack. Other variations of construction include providing individual dilute or concentrate cells, or cell pairs, by assembling modular units of two (or three) membranes sealed to one (or two, respectively) spacers; providing inlet/outlet conduits that extend transversely through all cells. Great variations are also possible in the presence, type, ratio and spatial distribution of exchange media, resins or packings.

The dilute and concentrate chambers of the prior art device such as shown in FIG. 1 generally have a thickness many times greater than the diameter of the ion exchange beads filling the chamber. As a result, ion capture, conduction and release processes in the filled cells are those of a thick bed, wherein multiple ion exchange beads of different types form part of the ion conduction pathway for a substantial portion of the removed ions.

FIG. 1A illustrates details of the resulting water splitting, desalination and re-contamination processes that occur in a typical EDI dilute cell of the prior art. As shown in the figure, many anion- and cation-exchange beads span the distance between membranes, so that chains of beads are involved in ion transfer, and these present various possibilities for ion migration. During the time when electric current is ON, an electric field is established that governs the general direction of movement of positive and negative ions. In the mixed bed of cation (C) and anion (A) exchange resin beads, there will be four types of bead-to-bead (or bead-to-membrane) junctions, which will be schematically represented in the text herein by the notations C→C, A→A, A→C, C→A, where C and A indicate a cation exchange material and an anion exchange material, respectively, and the arrow “→” indicates the electric field direction. By the process of electro-diffusion, salt cations are transferred from the surrounding water to the cation exchange beads C, and salt anions are transferred from the surrounding water to anion exchange beads A under local limiting current at the junctions A→C. Hydrogen and hydroxyl ions start to participate significantly in the process of current transference when the current exceeds the limiting value, in a process known as ‘water splitting’. Thus, salt sorption and hydrogen and hydroxyl ions generation occurs at the junctions A→C (water splitting junctions) when local current density here exceeds limiting value. Because of salt sorption, the solution conductivity decreases near the water splitting junctions A→C; this process increases the electrical resistance of the water locally, decreasing the local current density and decreasing hydrogen and hydroxyl ion generation at these ons as well. Due to electro-diffusion in the surrounding fluid, hydrogen and hydroxyl ions generated at the junctions A→C reach other cation and anion beads accordingly, where their presence makes possible salt ion sorption at these grains as well. But at the reverse junctions C→A, cations already traveling in the cation bead C of the pair cannot be transferred through anion bead A, due to Donnan exclusion. Thus, at the reverse junctions C→A, salt ions that had been previously sorbed and are traveling in one bead simply re-enter the surrounding water and locally re-contaminate the treated fluid. This recontamination lowers the reverse junction impedance, and increases the local current density. The overall process results in current re-distribution between water splitting junctions and reverse junctions, and this effect causes further water re-contamination to occur.

Thus, the thick bed fillings of the prior art result in an intrinsically “grainy” current distribution and a level of salt-throwing that re-contaminates the flow through the EDI chambers. The overall effect may be to define an upper bound on the degree of ion removal achieved by the EDI unit (e.g., limit the achievable water quality), and to affect the rate, electrical efficiency and other aspects of operation in addition to the conductivity endpoint.

The present invention addresses this drawback of the prior art by providing an electrodeionization apparatus or method of operation wherein cells are thin (in the direction of the applied electric field) and contain ion exchange material, such as beads, with a packing such that substantially every bead conducts directly, or along a direct path, to an adjacent membrane. The resulting packing density (i.e., the ratio of bead cross-sectional area to total cell cross-sectional area) is well below maximal density. This distribution of exchange material is called a “sparse” or “spare” distribution herein, and is best understood from consideration of several examples below. Illustratively, examples will be described having a bead bi-layer, a bead monolayer, certain three- and four-layer constructions, and a bead distribution which is both a monolayer and is comprised of isolated or non-contiguous beads. The isolated beads may form an ordered or regular pattern, or may form a more random distribution. Further embodiments of the invention include material (such as adhesive) or structure (such as a mesh) to define, to fix or to restrain the position or spatial distribution of the sparse filling. These and other features will be understood in connection with FIG. 2, showing features of an EDI apparatus according to the invention.

FIG. 2 illustrates an enlarged detail view of one embodiment of an EDI apparatus 100 of the present invention, showing representative cells 107, 109. The cells 107, 109 correspond to cells 7, 9 of FIG. 1, and are defined between permselective anion or cation exchange membranes (denoted “A” or “C” as in FIG. 1) that are spaced a small distance apart. By “small distance” is meant, a distance only about one or two times the nominal dimension of the ion exchange medium (for example, the diameter of beads) loaded in the cells. The distance is small compared to conventional filled dilute cell thickness, and thus provides a short ion transport path length to the adjacent membranes C, A (in the dilute cells) or provides an electrical bridge of low-resistance between the opposite membranes (in the concentrate cells). For this reason, stacks with the cells of the present invention offer improved speed, capacity or electrical efficiency, as compared with conventional EDI stacks. The stack of FIG. 2 is constructed with a first spacer/gasket 110 forming the perimeter around the dilute cells 107 and a second spacer gasket 120 forming the perimeter of concentrate cells 109, each spacer thus defining a open central region which forms the corresponding dilute or concentrate chamber. Ion exchange beads 125 in the chambers support and separate the membranes A, C in the central or interior region of the spacers, so that the membranes remain a certain minimum distance apart, and suitable flow may be maintained through the cell in operation. For simplicity, the bead distribution is explicitly illustrated in only one dilute and one concentrate cell. One or both types of the chambers may also contain a screen or mesh, of which the strands 140 are visible in this sectional view, and shown in one concentrate cell 109 of FIG. 2. The mesh, if used, may be dimensioned to prevent migration of the exchange beads 125 along the plane of flow, preserving the initial distribution of ion exchange material and preventing localized accumulation, sedimentation or depletion of beads or redistribution of bead types within the cells. In various embodiments, the spacers 110, 120 can be formed integral with the screen mesh (e.g., by injection molding) or may be assembled therewith (e.g., by cementing and sealing one or more, e.g., upper and lower, gasket portions around the perimeter region of the mesh), or may be formed by a process such as screen-printing a curable polymer such as EVA into the border region of a mesh. Further, the mesh may be formed of high tensile strength material, so that it provides a tensile restraint that preserves the original, generally rectangular shape of the spacer, e.g., prevents bulging-out or extrusion of the peripheral portion of the spacer. Use of such a structurally strong mesh material permits the cells to be placed under higher interior hydraulic pressure, or to be bolted in a stack with higher-torque compression bolts, without dimensional shifting, bulging or extrusion of the spacer material.

FIG. 2A shows a schematic representation of water splitting and desalination in one embodiment of a sparse distribution EDI dilute cell stack of the present invention, illustratively having a bi-layer of exchange beads. The illustrated sparse bi-layer is an ordered bi-layer, with a first layer of substantially only anion exchange beads AX lying adjacent to the anion exchange membrane A in the dilute cells, and a second layer of substantially only cation exchange beads CX lying adjacent to the cation exchange membrane C. As shown, negative ions may be captured by the AX resin and travel directly to the adjacent anion exchange membrane, while positive ions may be captured by the CX resin and travel directly to the adjacent cation exchange membrane. At junctions of the anion and cation exchange beads water splitting regenerates the ion exchange material. With this ordered bi-layer, there are substantially no beads of different exchange type positioned in the anion or cation conduction paths, hence no misoriented (dead-end) reverse junctions C→A.

As discussed above, the creation of an ordered bi-layer in a cell under about a millimeter thick requires careful assembly. Moreover, because exchange beads are often loaded in a salted form of reduced dimension, and may tightly fit against the cell walls only after hydration or after operation of the EDI unit, the initial positional stability of the beads constituting the layer may be poor. It would be desirable to maintain the ordered layer position of cation exchange beads and anion exchange beads, however, because when the layer structure is intact, each ion captured by a bead is transported directly to a concentrate cell. That is, the path length and the impedance are minimal and efficiency is optimal.

FIG. 2B shows in a schematic exploded perspective view, an illustrative embodiment of an EDI stack 200 of the present invention, wherein both the concentrate cells 205 and the dilute cells 203 are constructed with a sparse distribution. The stack is comprised of first and second end plates 206a, 206b that are bolted together via through bolts with first and second electrodes E1, E2 and the stack of alternating cells 203, 205 therebetween. The stack further includes electrode support and spacer structures, and electrolyte cell filling (not shown) as known in the art. The concentrate cells and the dilute cells are each defined by a respective spacer having a solid body perimeter portion 205a, 203a and a central open region 205b, 203b, respectively, and a selectively permeable, e.g., ion exchange, membrane M (illustrated schematically) overlying each of the open regions and secured between the spacers defining each cell and the next. Only three dilute cells and two concentrate cells from the middle of the stack are shown, but in commercial constructions the stack will generally include between fifteen and several hundred cell pairs.

As illustrated in FIG. 2B, the body 203a, 205a of each spacer is thin, defining the effective thickness of each cell for holding a sparse distribution of beads or exchange resin. Ports 208, 209 in the dilute spacers 203, and ports 211a, 211b in the concentrate spacer 205 define the general directions of flow through the cells, and the flows in each compartment may be apportioned or uniformized if necessary by various ancillary constructions known in the art, such as full or partial dividers (215, shown in dilute compartments), open, screened or unfilled flow-equalization regions or compartments (not illustrated), and the like. In this construction, the stack may be assembled in an orientation with the cells horizontal by successively placing a membrane, a spacer, distributing the beads, closing with another membrane and continuing with spacer, beads and membrane in this manner until the desired number of cells have been completed. Advantageously, the media placed in the concentrate cells operates largely to increase the cell conductivity, and need be optimized as a general ion exchange material. Thus, the material may be selected for its conductive properties, resistance to chemical or thermal conditions or other such property. In the dilute compartments, the material may take any of the forms describe herein, as a mixed sparse bed, or a patterned distribution. One or both types of cell may include a mesh bead stabilizer screen, as indicated by screen 250 in the concentrate cells, and this may be a component of the spacer itself, or may be added separately with suitable registration or assembly procedures. Furthermore, the spacers need not have such different geometrical structure. They may be configured with substantially symmetric layout within individual spacers, or anti-symmetric port arrangements (as between dilute and concentrate spacers) configured to allow interchange of concentrate and dilute cells while keeping the flow conduits separate and overall operating conditions relatively similar for EDIR operation.

Thus, in the embodiment of FIG. 2B, both the dilute and concentrate cells contain a sparse distribution. In other embodiments, one or more sets of cells may be of a conventional thickness. For example, a portion of the stack or an internal stage may be arranged with only the concentrate cells having a sparse distribution. This may be desirable, for example, when a second stage is operated with a very low flow of relatively pure water (such as first stage product water) where a thicker or empty cell could present a high or irregular resistance.

FIG. 3 schematically illustrates water splitting and desalination in one practical embodiment of a bi-layer EDI dilute cell of the present invention that also includes a screen spacer 50. The screen spacer includes a screen, mesh or lattice-work, defined by a plurality of crossed strands or fibers 50a. The screen itself may be, and preferably is, secured to the spacer or perimeter gasket that closes the cell and separates adjacent membranes. The strands 50a of the illustrated screen have a mesh spacing of at least about several bead diameters apart, but preferably no more than about two to ten millimeters, and thus restrict the movement or positioning of the exchange beads, during cell filling, handling and/or operation, so that beads can neither shift very far nor agglomerate in one place. In various embodiments and methods of construction, the screen spacer may have a small mesh that facilitates laying down a uniform and effective bead distribution, and/or may have a possibly larger mesh that assists in maintaining the stability of the distribution once deposited. The mesh may also include bead-free areas that define open flow equalization or flow enhancement regions of the corresponding dilute or concentrate cell. According to this aspect of the invention, the inclusion of a screen in the filled cells, and the distribution of beads on the screen structure (which may, for example, be defined by screen-printing an appropriate pattern of bead-fixing adhesive on the screen to define open and filled areas) may perform many of the functions formerly accomplished by special inserted or molded accessories, such as inlet manifold flow distributors, bead retainers, and anti-channeling deflector vanes. Several assembly techniques are discussed below in which the screen spacer is provided in a filled cell as part of a practical and effective process of forming the sparse bead layers of the present invention.

The layers so formed may include a bi-layer, having a monotype first resin layer and a layer of opposite type deposited above it as shown in FIG. 3, or may be another of the sparse distributions described herein below. In one simple case, beads may be of relatively uniform size. However, a layer may be composed of beads having different particle sizes, such as beads having variation in size distribution, or mixtures of beads having a multi-modal size distribution. In general, the beads are to firmly contact the membranes of the cell, and such contact is most simply achieved using beads of fairly uniform size, or beads of several sizes or a distribution that collectively forms a stable layer. When using composite membranes with a highly swellable rubbery matrix, good contact between a bead and the adjacent membrane(s) is easily obtained for ungraded beads with a relatively wide size variation. Similarly, when sparsely-filled cells of the invention are to alternate with cells of conventional thickness, the swollen overfilled conventional cells assure sufficient pressure on the membranes to provide good bead-to-membrane contact in the adjacent sparse cells. Otherwise, when the cells are all of sparse type—that is, not filled but simply having a sparse distribution of beads therein, it is important to set the spacer (and screen, if used) dimensions to promote contact.

In the ordered bilayer distribution shown in FIG. 3, the screen aids in the cell assembly by allowing a first layer—illustratively a lower monolayer of anion exchange beads—to substantially fill the area between strands 50a; the strands 50a then support a second monolayer, illustratively of cation exchange beads, in a stable thin configuration above the first layer, so that each type of bead contacts the appropriate membrane. The illustrated screen has strands 50a that alternate at upper and lower levels. This multi-height screen aids in defining and preserving the ordered layer structure. As in the embodiment of FIG. 2A, the sparse distribution so obtained is free of reverse junctions. In this embodiment, the screen itself is formed of non-exchange material, and the diameter of filaments 50a is sufficiently small so that the filaments do not themselves block or prevent bead-to-membrane contact.

The foregoing drawings have shown round (spherical) idealized beads, for simplicity of illustration. However, in practice, ion exchange beads are a more irregular overall shape. The invention is not limited in its practice to the use of well-formed spherical bead shapes, nor to well graded, “monosphere”, uniform size or even to mixtures of uniform size beads. In referring herein to these beads, the term “size”, although used in an intuitive or vernacular sense herein, may be understood as including a distribution curve, a nominal size, a maximum/minimum diameter pair, a mean, modal or weighted average cross-dimension value, or other particle size characterization or value. Advantageously, when the beads are sparsely distributed in the space between two membranes, the sparsity of the distribution may allow membrane deflection over the inter-bead spans, generally enhancing the degree of membrane-to-bead contact or surface conformance (hence ionic conduction) achieved by the embodiments of the invention, allowing great leeway in size. A screen may be used in the chamber to enhance the bead packing and/or stability with diverse size resins, and the combination of these features allows the resin to be effective even when it contains beads of quite different sizes. Thus the bead size, screen mesh and spacer thickness may all be selected as appropriate to maintain effective conditions for assembly and operation. Functionally, the screen is especially useful in fixing the locations of beads or providing stability for distributions such as extremely sparse fillings, wherein each bead is isolated from and not supported by all or many of its nearest neighbors, or wherein beads cover only a low percentage of the cell membrane surface area, and/or wherein the bead distribution is comprised of beads of different sizes and/or is comprised of patterned regions such as layers and/or stripes. The screen also sets a minimum inter-membrane spacing, assuring an adequate flow cross-section and preventing membrane-to-membrane contact or shorting.

Some screen embodiments may further utilize the screen to initially define, as well as to later preserve, stripes or other monotype layer or sub-layer pattern structure in the sparse distribution. For example, by wet-sieving beads using a screen with about a twenty-mil mesh, beads having a certain size distribution (such as 18-23 mils) may be captured in or on the mesh by surface tension; or a narrower distribution may be physically held in the screen openings and the remaining beads may be brushed off the top, leaving an intermediate assembly, consisting of the screen and attached monolayer of beads, that may be freely handled and assembled into a stack, either as a sparse monolayer, or as one part of a bi-layer distribution. A bi-layer may be formed with two such screens, or may have the second layer added by sprinkling a metered amount of the second layer material. Furthermore, by applying a contact adhesive to the screen, one may selectively adhere a monolayer of beads of a first type to one side of the screen, and beads of the same or a second type to the other side of the screen. The screen opening may be sized such that the beads of each side contact those on the other side. This produces a readily handled bilayer assembly which may be place directly between membranes of an EDI unit, or a selection of two such beaded screens may be placed between the membranes to form an ordered four-bead layer. Furthermore, by applying the adhesive to the screen, one avoids the occurrence of any adhesive layer between bead-bead contacts, so that the relevant electrical paths are unimpaired.

When an EDI device is operated to demineralize or purify water, it is often preferred that the apparatus employ both anion exchange and cation exchange resin types in the dilute compartments, although it is not necessary that the types be segregated into bands or an ordered bilayer.

FIG. 4 shows a schematic representation of water splitting and desalination in a mono-layer EDI dilute cell constructed in accordance with the present invention wherein the sparse distribution is a monolayer one bead deep, but formed of mixed bead types. That is, the monolayer includes anion exchange resin beads AX that are interspersed with cation exchange resin beads CX to constitute a sparse bead bed, pressed between the anion exchange membrane A and the cation exchange membrane C walls of the cell. The beads may have a defined ratio of type—e.g., 1:1 equimolar, 3:2 on a weight basis, or other fixed or selected ratio—but the two types are distributed, randomly or in bands, across the cell area in a single layer. Like the embodiments of FIGS. 2A and 3, this construction also eliminates reverse bead junctions C→A, and brings about a similar improvement in EDI performance. In particular, the elimination of ion release at reverse junctions removes a source of residual re-contamination and results in a high level of product purity, while the same factor results in a generally greater and stochastically uniform cell conductivity and generally better electrical efficiency due to the avoidance of unproductive splitting events.

FIG. 5 illustrates another embodiment of the present invention, and schematically shows the processes of water splitting and desalination in a mono-layer EDI dilute cell constructed as in FIG. 4, but additionally including a screen spacer positioned in the cell. The strands 50b of this spacer restrict the movement of exchange resin beads and generally maintain the beads in the positions fixed during the cell-filling process, with the result that the stack assembly procedure is greatly simplified while achieving a stable uniform bead distribution. The illustrated screen has its strands placed in the same plane, and their thickness is preferably somewhat less than the bead diameter, so the screen does not impair membrane-to bead contact. However, as shown in detail, the beads may include smaller-diameter beads, and the strands of the screen may support beads that are, to a certain extent, heaped up into contact with a membrane. Thus, dependent on mesh size, strand diameter, and bead size and distribution, bed thicknesses that vary from one bead upwards to one and a half or two beads may be dependably formed with good membrane contact and substantially free of reverse junctions.

Advantageously, an assembly process for packing the EDI flow cells may be carried out to form very uniform packings of one or several layers by following steps that start by placing exchange beads on a screen member, and then assembling the screen member between membranes. In this process the screen may have a mesh size greater than the bead size, and in one aspect of the method, the screen first captures at least a portion of the intended quantity of beads. Further beads are then picked up, for example by electrostatic attraction to the exposed surfaces of the initially-captured beads, further loading the screen assembly so that it is entirely covered by beads but not compacted. This sheet of bead-covered screen is then assembled between membranes, compactifying the beads into a well conducting layer. Intermediate stages of this process are illustrated in FIGS. 5A-5C.

In FIGS. 5A, 5B and 5C, “S” indicates a filament of a screen spacer. Initial beads are fixed on the screen. This may be done by forces of surface tension, adhesion, electrostatic, magnetic or electronic interaction. For example, the screen may be wetted and its mesh sized such that beads adhere to the screen by surface tension of the liquid. An adhesive may be applied to the screen and a quantity of beads then applied to the screen such that the beads stick thereto. Alternatively, beads having magnetic particles may be employed with a screen that includes magnetic material, so that an initial quantity of beads sticks to the screen by magnetic attraction. FIG. 5A illustrates the situation wherein beads have been adhered to the screen, so that the exchange beads appear relatively dispersed, essentially only in contact with the screen filaments. The screen may be adhesive-coated so as to pick up the beads, and the beads may be selectively contacted to the screen so that cation and anion exchange beads are on opposite sides. This step may be carried out with a screen having a mesh size slightly smaller than the bead diameter (not illustrated), such that a substantially continuous cation bead layer is formed on one side, and a substantially continuous anion exchange bead layer is formed on the other side of the screen, and the two types of beads contact each other at single junctions through the mesh openings. However, FIG. 5A illustrates a wider mesh, which is used to produce a spaced-apart, screen-attached bead distribution. FIG. 5B illustrates a second stage which may be used in forming the bead distribution on a screen prepared as in FIG. 5A, but starting with a mixed resin distribution. In this stage, which is preferably carried out under dry conditions, additional exchange beads indicated by asterisks (*) have attached themselves to the bead/screen assembly by electrostatic attraction—that is anion echange beads denoted A* have attached to the existing cation exchange beads C, and cation exchange beads denoted C* have attached to the existing anion exchange beads A. The resulting distribution self-assembles into a substantially continuous but loose mat attached to the screen. Depending upon the quantity of applied resin, the final assembly may amount to less than a complete layer, or the sparse bead distribution may form a one-, two-, three-, four- or multi-layer stabilized and fixed on a screen by forces of surface tension, adhesion, electrostatic, magnetic or electronic interaction The assembly may be then freely handled, and assembled between ion exchange membranes to form a working EDI apparatus. At this point the beads become more firmly packed, as shown in FIG. 5C.

Other possible mechanics of stack assembly with a sparse distribution in a thin EDI cell will now be further considered. It will be appreciated that a large-area dilute or concentrate cell having a thickness below two millimeters presents special constraints that may pose problems for effective filling. Applicant has developed several EDI manufacturing or filling methods to achieve effective sparse bead distributions within the completed cell. The tasks that are addressed by these methods involve distributing the beads sparsely but uniformly; forming a bilayer of different types of beads (for the bilayered embodiments such as shown in FIG. 4) or otherwise distributing in a predetermined pattern (e.g., stripes); and depositing the beads only in the flow treatment regions of a cell and not on sealing surfaces. The term “uniformly” will be understood, in the case of extremely sparse distributions to include uniformity in a stochastic sense. Thus, the distribution provides beads that are close together and covering the entire flow treatment area, although any given small area may happen to be free of beads, or have greater than the average ratio of one type.

In practice, the requirement of forming a sparse distribution such that beads lie only within the cells and away from the sealing spacer-membrane surfaces would appear to require relatively costly manufacturing techniques. However, in addition to the screen-fixing methods and structures described above, the invention includes several methods and specialized apparatus, described below, which address one or more of these problematic areas of sparse cell construction.

FIG. 6 illustrates one device 100 and method for distributing beads in an EDI cell for the practice of this invention. The device 100 is intended for use in fabricating individual cells, or fabricating a stack in a layer-by-layer sequence, and it operates by spreading the beads along the central open region R of a template, which may, for example, correspond to the open central region of a perimeter spacer/gasket one or two beads thick as described above. The device includes a mechanized bead sprinkler having a vibrated sieve to regulate and disperse beads. The sprinkling assembly (or sieve, not visible in the Figure) is installed on a platform or carriage 105, which is moved relative to a base support 106 or frame. The base 106 is positionable above the cell which is to be filled, and the open region R aligns with the central region of the spacer. The platform 105 is moved along the base platform by a drive mechanism, e.g., a belt or chain 107, coupled to a suitably controlled gear motor 108, or may be moved by other means such as a stepper motor or hydraulic drive. Platform motion and sprinkler operation are controlled to deposit the desired bead distribution. When the moving platform reaches the end of the spacer, it may, for example, activate a switch that stops the carriage and/or reverses its travel. The sprinkling mechanism may employ a sieve having openings less then two bead diameters across, so that due to the relatively congested size of the sieve openings, beads jam and stop up the sieve openings very easily when the screen is not being actively vibrated, and sowing quickly stops. When vibration is applied, however, shifting of beads jammed in the opening frees the beads to fall through the screen mesh opening, restarting the flow of beads through the sieve. Seeding of the IX resin onto the membrane (as well as the total density of IX resin deposition along spacer) may then be precisely regulated, not only by the speed of the carriage movement along the spacer, and the sieve area, but control of related conditions, such as the frequency and amplitude of the sieve vibration.

An exchange resin storage unit or supply conduit, which may contain two or more separately controlled subunits for different IX resins, feeds the sieve/spreader mechanism 100. By varying the moving platform speed, or the frequency and/or amplitude of sieve vibration, it is possible to change the density of IX resin spreading along the length of the spacer flow path, and to also change the ratio between the different types of exchange resins deposited at each point of the mixed bed along the flow path. The carriage travel, sieve vibration regimen and other parameters are programmed to deposit the desired distribution of ion exchange beads in the cell, allowing the construction of uniformly-assembled multi-cell EDI stacks.

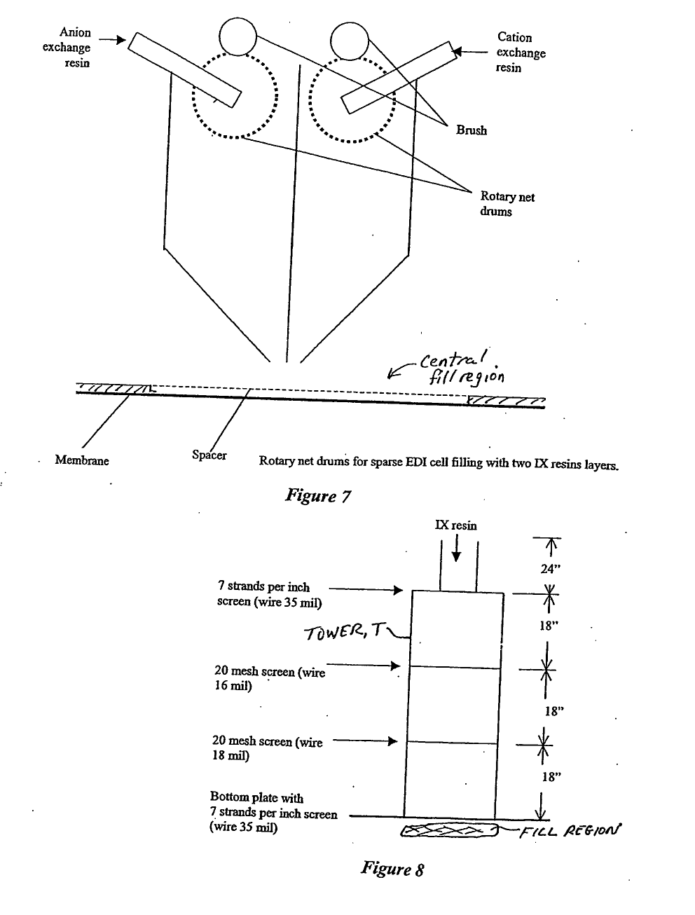

Applicant has developed other controllable distribution or bead depositing mechanisms for sparse distribution EDI cell construction in accordance with this invention, and these may be operated, or modified for operation, to vary the density, type ratio or other aspect of the deposited media. In one such embodiment, the carriage supports several revolving screen drums, one for each for type of resin, with or without a vibrated sieve, to distribute the IX resins. Such an applicator mechanism is shown in FIG. 7. In this embodiment, two bead-dispensing drums dispense beads into a slope-walled sprinkling hopper that funnels the beads to a narrow slot from which the beads drop onto the central membrane region of an EDI cell below.

Applicant has also developed another useful resin distributing device, having the general form of a sprinkling tower. FIG. 8 illustrates one embodiment of this unit schematically for distribution an IX resin along the open center of an EDI spacer in a layer one or two beads deep, without requiring a moving transport. A tall closed tower T is provided as a chimney-like structure alignable over the flow cell, that is positioned or installed on top of an EDI spacer. The vertical walls of the tower are coincident with the inner edge of the spacer, and the tower is aligned therewith, then removed after each bead filling while the next membrane is laid down.

In operation, a controlled stream of resin beads is provided at the top or upper region of the tower, and one or more screens extend across the chimney interior at different heights. The stream or a measured portion of an IX resin (or a mixture if a mixed mono-layer EDI-Sparse distribution is desired) is poured from the top of the tower, and falls down the chimney, colliding with the intermediate screens, which have meshes adapted to spread the beads. The velocity and the direction of the falling beads are both randomized by collisions with the chimney wall and with the screens as the beads fall. One or more of the screens may be vibrated or oscillated, to assure non-clogging and/or to impart lateral component(s) of motion to beads passing therethrough. The relative heights of the screens from each other, and from the underlying cell may be adjusted based on experimentation, to assure that the resulting sparse distribution of beads lands in a substantially uniform spread without edge voids or ridges. The higher screen or screens may have generally smaller mesh effective to hit, and thus spread, and to sift the beads over the full available area, while a lower screen may have a larger mesh that more readily passes the spread distribution.

A screen tower as described may also be configured with the screens or other members (such as a honeycomb) dimensioned and positioned to slow down the falling beads and collimate their direction, substantially damping or removing lateral components of motion before landing so that the beads more dependably stay where they land. The underlying membrane may also be wetted to assure that beads stick in position and do not bounce away during assembly of successive components onto the stack. Measures such as this can prevent the formation of regions of zero density or of doubled density close to the perimeter wall, enhancing the stochastic uniformity of the bead deposit.

### EXAMPLE 1

Two IONICS 4″×20″ EDI stacks of eight cell pairs were assembled. One had conventional 120-mil thick dilute cell spacers and the other had dilute cell spacers thirty mils (0.75 mm) thick, effective to define a bi-layer dilute chamber. Layers of beads were distributed and fixed onto the membanes in the central region of the 30 mil spacers by sieving onto a wetted membrane that was covered with a nine strand per inch screen. The screen maintained the deposited beads in position. Both stacks employed the manufacturer's customary anion exchange and cation exchange membranes, and the customary anion exchange and cation exchange resin beads. The two stacks were both tested at a flow rate 0.32 GPM, with a feed water having conductivity of 23 μm/cm and silica loading of 650-695 ppb.

Table 1 shows the test results. The sparse bead EDI device performance is characterized by higher product resistance, better silica rejection and lower overall stack electrical resistance. The differences in these parameters were substantial, and indicate potential not only for reduced materials expense but greater energy saving and enhanced controllability or performance. The thin cell results also suggest the possibility of assembling a much greater number of cell pairs between two end-blocks to form an EDI stack that would increase stack capacity without impairing product quality.

TABLE I
Regular and Bi-layer EDI-Sparse comparison.

| | Cell | | 8 cell pair | | |
|---|---|---|---|---|---|
| | volume | | stack | | |
| | fraction | IX resin | electrical | Silica | Product |
| | filled with | volume ratio | resistance, | rejection, | resistance |
| | resin, % | Anion:Cation | Ω | % | MΩ-cm |
| Regular | 100 | 1.65 | 30.3 | 68 | 13.37 |
| Bi-layer | 74 | 1.12 | 16.8 | 95 | 17.35 |
| sparse | | | | | |

### EXAMPLE 2

The surface specific resistance (in Ohms * sq. cm) of one EDI cell having a conventional cation exchange membrane was measured in two series of experiments. In the first series of experiments a conventional screen spacer #3792 (Naltex R) was used with no resin filling. In another series of experiments the same screen was covered by 60 mg/sq. cm of cation exchange resin 650C which was UPW fixed on the screen with Glycerol. A probe current range of 1-5 mA/sq. cm DC was used to carry out surface specific resistance measurements with Na2SO4 test solution having conductivities between 200 and 600 μSm*cm. Cell thickness was 1.60 mm. Results are shown in Table 2.

TABLE 2
EDI cell surface specific resistance (Ohm * sq. cm)

| Na2SO4 | Cell without cation | Cell with cation |
|---|---|---|
| solution conduct. | exchange resin, | exchange resin, |
| μSm * cm | Ohm * sq. cm | Ohm * sq. cm |
| 200 | 1500 | 110 |
| 400 | 1180 | 84 |
| 600 | 1025 | 83 |

The data in the Table show that distributing 60 mg/sq. cm of cation exchange resin 650C-UPW in the spacer fixed on the screen by Glycerol results in a ten-fold reduction in the EDI cell surface specific resistance.

### EXAMPLE 3

A three cell 4″×20″ sparsely filled cell EDI stack (active area 170 sq. cm) with two electrode cells and one dilute cell was built using customary anion exchange and cation exchange membranes of Ionics, Incorporated EDI constructions. The dilute cell was formed with a screen spacer unit formed of 20 mil PE or EVA film melt bonded with a #4610-Naltex R (20 mil) screen. Then, one side of the screen was covered by 4.7 g of dry Dowex Monosphere 550A UPW (OH) anion exchange beads and the other was covered by 0.85 g of a mixture of Dowex Monosphere 650C UPW (H): Dowex Monosphere 500C NG (H)=1:1. The dilute cell contained 85% of 550A UPW (OH), 7.5% of 650C UPW (H) and 7.5% of 500C NG (H). All IX resins were fixed on the spacer by Glycerin. Each electrode cell had a Ti/Pt electrode and was formed by one 4×20 inch regular IONICS EDI electrode spacer (net #3957C, thickness −0.70 mm) covered by 3.00 g of dry 650C UPW fixed by Glycerin.

The current was 1010 mA, inlet water specific resistance was 7.75 MOhm*cm, TOC −43 ppb, flow rate through anode and cathode cells −1.07 ml/min, through dilute cell −122 ml/min. A pressure drop of 13 psi was measured, and the product specific resistance was 17.9 MOhm*cm, with residual TOC of 22 ppb.

These results show quite high performance of a sparse bead EDI unit having IX resins fixed on the spacers by a non-polymer organic liquid.

### EXAMPLE 4

A three cell 4″20″ EDI unit (active area 170 sq. cm) with two electrode cells and one dilute cell was assembled with IONICS homogeneous anion exchange and cation exchange membranes. The dilute cell was formed by 20 mil PE film melted together with a #4610-Naltex R (20-mil) net and covered by 1.0 g of dry 550A UPW and 0.5 g of dry 650C UPW, in eight stripes arranged in a ‘Zebra’ pattern. Vaseline was used to fix the IX resins on the spacer. Each electrode cell had a Ti/Pt electrode and a spacer unit formed by 20-mil PE film melted together with the same screen and covered by 3.0 g of dry 650C UPW and fixed on the spacer by Vaseline. The current was 1047 mA, with inlet water specific resistance of 7.04 MOhm*cm, and TOC of 40 ppb. The flow rate through the dilute cell was 54 ml/min; flow through anode cell was 2.8 ml/min and flow through the cathode cell was 0.97 ml/min. The pressure drop was 13 psi, and the product specific resistance was 17.9 MOhm*cm with a measured TOC level of 11.0 ppb in the product water. This operating data demonstrates a high level of performance of the sparse bead EDI assembly in which a sparse distribution of ion exchange beads is fixed on the spacers by a non-polymer organic adhesive (e.g., vaseline).

As is apparent from the above discussion, the sparse distributions of the present invention pose a unique set of problems for the manual, mechanical or automated assembly of EDI stacks in a uniform and repeatable way. These problems can be addressed by various mechanical sprinkling or metering assemblies, temporary or permanent fluids or adhesives for bead immobilization on the screen or membrane, and screens that selectively retain like-dimensioned beads or that stabilize deposited beads against shifts in distribution. The resulting improvements in cell conductivity, speed of ion transfer, and electrical efficiency permit the application of robust flow or electrical control regimens, so that the sparse EDI stacks may be operated, for example, to assure that particular impurities (such as polyvalent ions) are removed in a specific portion of the cell flow path, or may be operated to maximize current efficiency or other parameter, or avoid salt-throwing or unwanted hydrolysis, or develop stacks that have higher capacity for demineralizing flows. Dynamic deionization models may be applied to anticipate and control pH, scaling, water splitting and other conditions occurring within the stack. Reference is made to commonly-owned International Application PCT/US01/25226 for further descriptions of specific desirable controls which, with a sparse exchange distribution in one or more sets of cells, form further embodiments of this invention. That application, published as WO 02/14224, is hereby incorporated by reference herein in its entirety. Other commonly-owned U.S. patents disclose advantageous control techniques involving the use of monotype or specialized resins along specific portions of the feed or concentrate flow paths. Such control may be advantageously practiced in embodiments of the present invention, wherein the screen immobilization allows a resin distribution pattern to be precisely defined and maintained, and the sparsity of bead distribution allows the underlying deionization performance or ion-transfer functions to be more precisely quantified and performance predicted. Thus, when the stack is used in conjunction with a controller that responds to changes in feed or product water characteristics, the controller may more closely achieve a desired set point with feedforward or feedback control.

It will be understood that in the prior art stacks as described generally herein, a number of cells are stacked in series between the electrodes. The electrodes are impressed with a voltage effective to establish a potential difference of up to about five volts across each cell, typically employing a power supply capable of providing as much as fifty amperes of current at a total potential of several hundred to over one thousand volts, depending, inter alia, upon the number of cells in the stack and their thickness. In practical applications, a controller may control the current or voltage level based on one or more measurements or control parameters, or may be operated to maintain a specific constant current level (e.g., so that the voltage changes in accordance with fluid impedance), a specific constant voltage level (e.g., optimized for ion removal from a specific feed), current efficiency for total equivalent ion removal, or other value. The cited electrical values are approximate only, and correspond to a typical range of common EDI industrial stack sizes, cross-sectional area and construction. The adaptation of such power supplies, operating control regimens and the like for stacks of the present invention may be largely carried over or modified from the prior art for use with sparse bead stacks of the present invention. Advantageously, however, the sparse stacks have enhanced electrical efficiency and do not suffer from bead segregation, non-conductive pockets or extreme polarization or splitting, and other problems of conventional thick bed EDI. Thus, stacks of the invention may be operated entirely within well-defined operating ranges, and the operating protocols and ancillary drive and control equipment will allow effective operation at lower overall operating voltage or power levels and/or better-defined internal stack state conditions.

The invention may also be practiced with overall EDI architectures other than the illustrated stacks. Thus, the sparse distribution may be embodied in cylindrical, spiral-wound EDI units, as well as in cylindrical stacked EDI units with disk-shaped cells, or in various forms of single-chamber laboratory or specialized process EDI units, and other general architectures as known in the art. Flows in the dilute cells and the concentrate cells may be the same (co-current), or may be opposite (counter-current), and concentrate flow may be provided by a circulating brine loop (commonly used when the concentrate cells are unfilled), by a bleed from the dilute feed or from the product, or by a circulating loop replenished by bleed and maintained at an effective concentration by blowdown, fed by an independent fluid source or by other means. Constructions herein are illustrative only, and it will be understood that EDI apparatus may take quite distinct forms, with divided or multi-channel cells, series connection or bleeds from different cells or channels, and various constructions involving multiple membranes, bipolar membranes and subsidiary fluid flows, as well as a great variety of ion exchange resin types, combinations and localized or segregated fillings. Furthermore, rather than beads, the invention may be implemented with “bumpy” ion exchange membranes, wherein sparsely distributed bumps or ridges protrude from the nominal surface plane of the exchange membrane, rather than using separate beads urged against the surface. Sparse filler materials such as felts or screens formed of ion exchange or ion conductive media, and other materials may also be used in the practice of the invention, potentially simplifying the distributing and stack assembly steps.

Particular constructions may employed structured patterns of bead types along the flow path, including, for example: graded AX-CX beads changing in relative proportions of each type along the flow path; pure monotype resins or bands of monotype with bands of mixed resins, such as anion monotype followed by a band of heterogeneous beads followed by a a cation monotype region; an AX-enriched filling changing to a CX-enriched one. The different patterns constituting the distribution may be applied, for example, to remove silica or boron at an early stage along the treatment line.

The invention being thus disclosed and illustrative embodiments described, further variations and modifications lying within the scope and spirit of the invention will occur to those skilled in the art, and all such variations and modifications are considered to be part of the invention as defined herein and by the claims appended hereto.

1. An electrodeionization apparatus comprising dilute cells and concentrate cells defined between ion permeable membranes, said dilute and concentrate cells being arranged between an anode electrode and a cathode electrode, and configured such that ions present in a flow of feed water passing through a dilute cell are captured by exchange resin and move under influence of an electric potential applied by the electrodes into adjacent concentrate cells, being thereby removed from the flow so as to form an at least partially deionized product water, and wherein at least some of said cells contain a sparse distribution of ion exchange resin.

2. The electrodeionization apparatus of claim 1, wherein the ion exchange resin includes beads having a nominal diameter, and the dilute cell has a thickness under about twice said diameter, said sparse distribution having a packing density effective to maintain membrane spacing and to effect ion conduction across the cell while providing an effective flow-passing porosity.

3. The electrodeionization apparatus of claim 2, wherein the sparse distribution is a bed of beads having a thickness of approximately two diameters.

4. The electrodeionization apparatus of claim 2, wherein the sparse distribution is a layer having a thickness of approximately one diameter.

5. The electrodeionization apparatus of claim 1, wherein the sparse distribution is a bed selected from among a mixed bed, a layered bed, a striped bed, a graded bed and a monotype bed.

6. The electrodeionization apparatus of claim 1, wherein the sparse distribution is stabilized in position by a mesh.

7. The electrodeionization apparatus of claim 1, wherein the sparse distribution is a distribution of beads and the apparatus contains a screen having a mesh size greater than one bead dimension for stabilizing the filling.

8. The Electrodeionization apparatus of claim 1, wherein the sparse distribution is stabilized by beads fixed on a screen by adhesion, electrostatic, magnetic or electronic interaction.

9. A method of filling an EDI cell, such method comprising the steps of
assembling a spacer on a first membrane, wherein the spacer defines a fluid flow region adjacent the first membrane
sprinkling ion exchange beads into the flow region as a sparse distribution, and
assembling a second membrane over the spacer
thereby forming a sparsely filled EDI cell.

10. The method of claim 9, further comprising the step of providing a mesh in the flow region, the mesh forming a reticulation of strands criss-crossing the flow region such that the mesh segregates and supports the beads of the sparse distribution.

11. An EDI apparatus according to claim 1, wherein the sparse distribution is comprised of substantially mutually separate ion exchange beads in the cell for stripping ions from fluid passing through the cell and conducting stripped ions to an adjacent membrane.

12. The EDI apparatus of claim 11, wherein a substantial portion of said mutually separate ion exchange beads contact both said anion exchange membrane and said cation exchange membrane.

13. The EDI apparatus of claim 12, wherein the substantial portion of beads are urged into deforming contact at surfaces of said anion exchange membrane and said cation exchange membrane to provide enhanced conductivity therebetween.

14. EDI apparatus according to claim 1, wherein the sparse distribution comprises a monolayer of mixed type ion exchange beads positioned between the anion exchange membrane and the cation exchange membrane.

15. EDI apparatus according to claim 1, wherein the sparse distribution comprises a layer substantially free of bead-to-bead reverse junctions.

16. The EDI apparatus of claim 15, wherein said layer is a monolayer or an ordered bilayer.

17. EDI apparatus according to claim 15, comprising ion exchange beads including anion exchange beads and cation exchange beads for stripping ions from fluid passing through the cell, said beads being positioned in a layer configured to not throw salt as applied voltage is increased in operation.

18. EDI apparatus according to claim 1, wherein the ion exchange resin includes anion exchange beads and cation exchange beads for stripping ions from fluid passing through the cell, said beads being positioned in a sparse layer of substantially non-contiguous beads substantially free of reverse bead junctions, and wherein individual beads contact both said first and said second membrane and conduct ions to a single membrane under influence of a transversely-applied electric field.

19. EDI apparatus according to claim 1 wherein a cell is defined between a first ion exchange membrane having protruding bumps of ion exchange material and a second ion exchange membrane, wherein the protruding bumps of ion exchange material support the first and second membranes apart defining a flow space under about one millimeter thick between said membranes said bumps comprising the sparse distribution of ion exchange resin.

20. An improved method of forming a resin filled EDI cell, such method comprising the steps of arranging a plurality of ion exchange membranes between a pair of electrodes configured to apply an electric field transversely to said membranes, and providing a sparse distribution of ion exchange material between adjacent ones of the membranes.

21. An improved method of purifying fluid by electrodeionization, wherein the improvement is characterized by the step of providing a sparse distribution of ion exchange material in one or more types of cells within an electrodeionization apparatus.

22. The method of claim 21, wherein the sparse distribution is provided in one or more cells selected from the group of cells consisting of dilute cells, concentrate cells and electrolyte cells, said sparse distribution comprising monotype resin (preferably in concentrate cells) or mixed type resin.

23. (canceled)

24. (canceled)

25. (canceled)

26. (canceled)

27. A method of forming a layer of ion exchange beads wherein the method includes the step of wet sieving beads through a screen to capture the layer in the screen.

28. (canceled)
